(19) United States
(12) Patent Application Publication
(10) Pub. No.: US 2026/0290309 A1
(43) Pub. Date: Sep. 24, 2026

(54) SYSTEM

(71) Applicant: SoftBank Group Corp., Tokyo (JP)

(72) Inventor: Hideki MORIWAKI, Tokyo (JP)

(73) Assignee: SoftBank Group Corp., Tokyo (JP)

(21) Appl. No.: 19/567,356

(22) Filed: Mar. 16, 2026

(30) Foreign Application Priority Data
Mar. 19, 2025 (JP) 2025-045287

(51) Int. Cl. G10L 13/033; G06F 40/40; G06V 10/82; G06V 20/40; G06V 40/16; G06V 40/20; G10L 25/63

(52) U.S. Cl. CPC G10L 13/033; G06F 40/40; G06V 10/82; G06V 20/49; G06V 40/176; G06V 40/28; G10L 25/63

(57) ABSTRACT

A system includes a processor that is configured to capture sign language using a camera and analyze captured video data to recognize content of the sign language, generate a prompt for instructing a generative AI model to generate text data so as to convert the recognized content of the sign language into the text data, and generate the text data based on the prompt by using the generative AI model, and convert the generated text data into audio data by using a speech synthesis technique and output the audio data through an audio output device.

### CROSS-REFERENCE TO RELATED APPLICATION

This application is based on and claims priority under 35 USC 119 from Japanese Patent Application No. 2025-045287 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional communication support systems for deaf or hard-of-hearing users generally rely on manual input, predefined templates, or limited vocabulary recognition, and therefore cannot flexibly and accurately convert natural sign language into spoken language in real time. In particular, conventional systems often fail to recognize continuous sign language from video, do not capture the nuance and emotional state of the user, and cannot generate natural, contextually appropriate speech output.

Furthermore, conventional sign recognition techniques frequently suffer from low recognition accuracy because they do not sufficiently analyze the temporal changes in sign language motion on a frame-by-frame basis, and they typically do not utilize advanced generative AI models to flexibly generate text data corresponding to recognized sign content. As a result, the generated text and subsequent audio output may be incomplete, unnatural, or semantically inaccurate.

In addition, conventional systems that generate speech from recognized sign language rarely take into account the facial expression or voice-related emotional cues of the user, and therefore cannot produce speech output that reflects the user's emotional state, such as happiness, sadness, or emphasis. This lack of emotional expression reduces the naturalness and effectiveness of communication between the deaf or hard-of-hearing user and a hearing person.

Accordingly, there is a need for a system that can accurately recognize sign language from captured video, generate appropriate text using a generative AI model, and convert the generated text into speech while reflecting the user's emotional state, thereby enabling more natural, accurate, and expressive communication between users.

### SUMMARY

In order to solve the above-described problems, a system is provided that comprises a processor configured to capture sign language using a camera and analyze captured video data to recognize content of the sign language. The processor is configured to generate a prompt for instructing a generative AI model to generate text data so as to convert the recognized content of the sign language into the text data, and to generate the text data based on the prompt by using the generative AI model. The processor is further configured to convert the generated text data into audio data by using a speech synthesis technique and to output the audio data through an audio output device.

According to one aspect, the processor is configured to recognize an emotion by analyzing at least one of a facial expression of a user and a tone of voice of the user, and to generate the audio data with a voice tone corresponding to the recognized emotion. By reflecting the recognized emotion in the voice tone of the synthesized speech, the system can output emotionally expressive audio that more closely represents the user's intended nuance.

According to another aspect, the processor is configured to capture the sign language using the camera, analyze the captured video data on a frame-by-frame basis, and recognize a motion of the sign language with high accuracy. By performing frame-by-frame analysis, the processor can accurately track temporal changes in hand shape, position, and movement, thereby improving the recognition accuracy of continuous sign language phrases.

Through these configurations, the system can automatically and accurately recognize sign language from video, generate appropriate text using a generative AI model, and output natural and emotionally expressive speech, thereby solving the problems of limited recognition accuracy, lack of flexibility, and insufficient emotional expression found in conventional systems.

The term “processor” refers to one or more hardware processing units, such as a CPU, GPU, ASIC, FPGA, or a combination thereof, that execute instructions to perform the functions of capturing, analyzing, recognizing, generating, and converting data as described herein.

The term “camera” refers to an image-capturing device, including a still camera, a video camera, a web camera, or any imaging sensor capable of acquiring image or video data of a user performing sign language.

The term “sign language” refers to a visual-gestural language expressed primarily through hand shapes, hand movements, orientations, body postures, and facial expressions, and includes any natural or artificial sign language used for communication by deaf or hard-of-hearing users.

The term “video data” refers to a sequence of image frames or moving images captured over time by the camera, which represent the motion and configuration of the user's hands, body, and face while performing sign language.

The term “content of the sign language” refers to the semantic information, linguistic meaning, or intended message conveyed by the user's sign language as interpreted by the system.

The term “generative AI model” refers to a machine learning model, such as a neural network-based generative model or large language model, that is capable of generating text data in response to an input prompt.

The term “prompt” refers to a structured input, including text or encoded data, that instructs the generative AI model to generate text data corresponding to recognized content of the sign language.

The term “text data” refers to character-based or symbol-based digital information that represents linguistic content, including words, phrases, or sentences generated by the generative AI model.

The term “speech synthesis technique” refers to any method, algorithm, or system that converts text data into audio data representing human speech, including but not limited to concatenative synthesis, parametric synthesis, and neural network-based text-to-speech methods.

The term “audio data” refers to digital information representing sound, including waveform samples or encoded audio streams that can be reproduced as audible speech by an audio output device.

The term “audio output device” refers to a device capable of converting audio data into audible sound, such as a speaker, headset, earphone, or other electro-acoustic transducer.

The term “emotion” refers to an affective state of the user, such as happiness, sadness, anger, surprise, or neutrality, which can be inferred from at least a facial expression or a tone of voice.

The term “facial expression” refers to visual features and changes in the user's face, including movements of the eyes, eyebrows, mouth, and other facial muscles, that can be analyzed to infer emotional or linguistic information.

The term “tone of voice” refers to acoustic characteristics of the user's voice, such as pitch, loudness, timbre, and prosody, that can be analyzed to infer an emotional state or emphasis, even when the user has residual hearing or uses vocalizations in combination with sign language.

The term “voice tone” refers to a set of parameters controlling the acoustic characteristics of synthesized speech, including pitch, intensity, speed, and timbre, which can be adjusted to correspond to a recognized emotion.

The term “frame-by-frame basis” refers to processing in which each image frame of the captured video data is individually analyzed, and temporal relationships among successive frames are considered to recognize motion patterns.

The term “motion of the sign language” refers to temporal changes in the position, orientation, and shape of the user's hands, arms, body, and facial features that constitute the dynamic components of a sign or sign sequence.

The term “high accuracy” refers to a recognition performance level that is significantly improved compared to conventional methods lacking frame-by-frame analysis, such that the system can reliably identify sign language content under practical usage conditions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

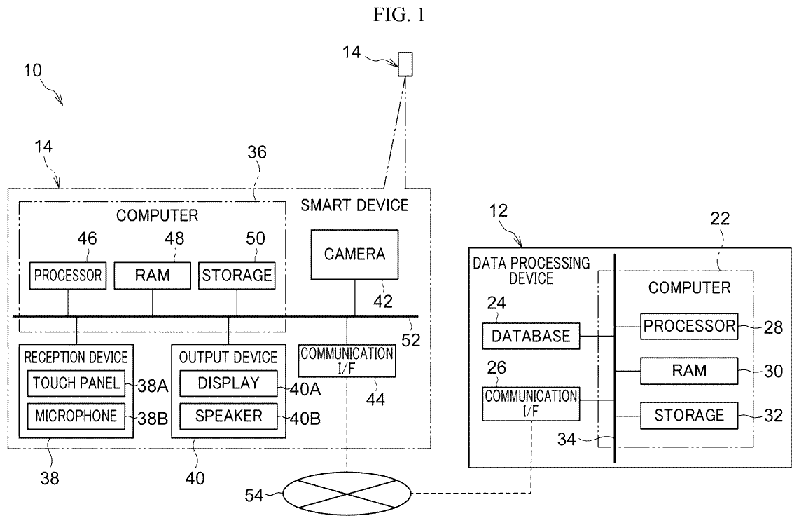

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

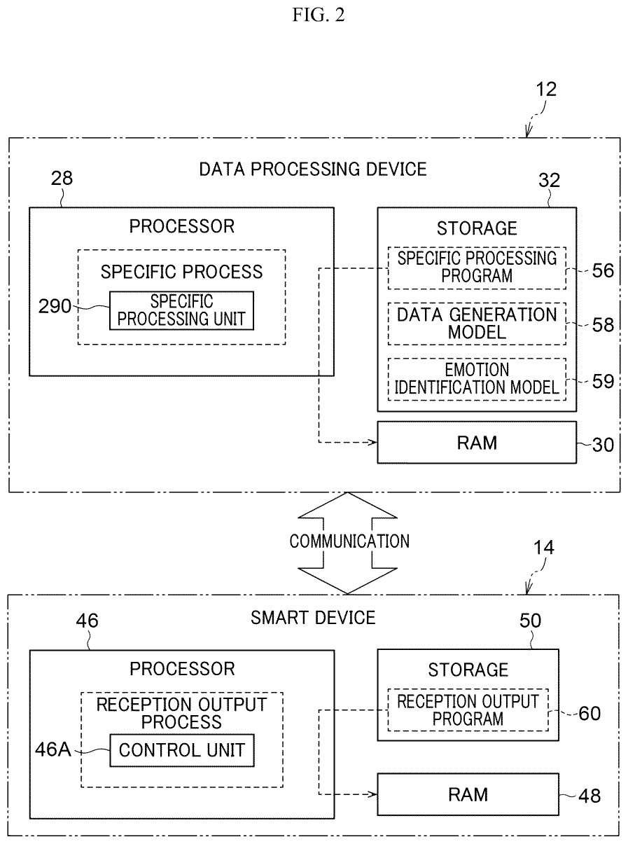

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional sign-language translation systems generally perform direct mapping from video frames of gestural movements to text or speech using static pattern recognition. Such systems often rely on limited feature extraction or simple frame-based classification, and therefore suffer from low recognition accuracy, unnatural output sentences, and latency when deployed in real-time interactive environments. In particular, these systems do not effectively exploit time-series segmentation of motion intervals, do not dynamically refine recognized content into natural-language sentences, and do not adapt speech output characteristics such as tone and prosody to user emotion. As a result, the overall human-computer interaction quality is degraded, and the underlying computer technology for multimodal communication assistance remains inefficient and inflexible.

In existing architectures, processors typically treat video, language, and speech as separate pipelines, which leads to redundant computation, poor utilization of machine learning models, and difficulty in scaling to diverse sign vocabularies and conversational contexts. Furthermore, conventional approaches lack a mechanism to systematically generate and use prompt sentences that condition a generative AI model, so that the textual output remains close to rigid label sequences rather than contextually appropriate natural-language expressions. This limitation reduces the usability of the system for real-world conversations and imposes additional cognitive and operational burdens on users.

Accordingly, there is a need for an improved computer-implemented technique that integrates time-series motion preprocessing, machine learning-based recognition, prompt-driven generative AI text refinement, and emotion-adaptive speech synthesis within a coordinated processing architecture. Such a technique should improve the accuracy, naturalness, and responsiveness of sign-language-to-speech conversion while efficiently utilizing computational resources and enabling flexible deployment across different terminal devices.

The specific processing by the specific processing unit 290 of the data processing device 12 in Example 1 is realized by the following means.

The present invention provides a server comprising a processor configured to acquire motion image information including gestural movement by using an image acquisition device, to perform preprocessing by dividing the motion image information into time-series image units and performing at least resizing, pixel-value normalization, body-part region extraction, motion-region cropping, and motion-interval segmentation; to input the preprocessed time-series image information or body-joint position information extracted from the image information into a machine learning model, to recognize character-string information representing semantic content of the gestural movement based on an output of the machine learning model, to generate a prompt sentence for instructing a generative AI model to generate character-string information in a natural-language sentence form based on a recognition result, and to obtain the character-string information in the natural-language sentence form from the generative AI model in response to the prompt sentence; and to input the character-string information in the natural-language sentence form into a speech synthesis processing unit, to generate audio parameters and speech feature values to thereby generate audio data, and to transmit the audio data to a terminal device via a communication path so that the audio data is output as physical sound through an acoustic output device connected to the terminal device. This enables improvement of computer-implemented sign-language processing by providing accurate time-series gesture recognition, contextually refined natural-language sentence generation via prompt-driven generative AI, and emotion-adaptive, real-time speech output within an integrated processing architecture.

The term “system” refers to a combination of one or more hardware components and one or more software components that cooperate to execute the processing described in the claims.

The term “processor” refers to one or more processing units, such as a central processing unit, a graphics processing unit, a digital signal processor, or any combination thereof, that execute instructions to perform arithmetic, logical, control, and input/output operations.

The term “image acquisition device” refers to a hardware device configured to capture image information, such as a camera, an image sensor, or any other optical capturing apparatus capable of obtaining motion image information including gestural movement.

The term “motion image information” refers to digital data representing a sequence of images captured over time and including at least a moving subject performing gestural movement.

The term “gestural movement” refers to a sequence of physical movements of a body part, such as a hand, arm, or facial region, used to convey semantic content, including but not limited to sign language expressions.

The term “time-series image units” refers to individual image frames or groups of consecutive image frames that are ordered in time and represent successive states of motion image information.

The term “preprocessing” refers to a set of operations applied to raw motion image information prior to recognition, including at least resizing, pixel-value normalization, body-part region extraction, motion-region cropping, and motion-interval segmentation.

The term “resizing” refers to changing the spatial resolution or size of an image to a target width and height suitable for subsequent processing or input to a model.

The term “pixel-value normalization” refers to transforming pixel intensity values of an image into a normalized range or distribution, such as scaling or standardizing values, to improve numerical stability and recognition accuracy.

The term “body-part region extraction” refers to identifying and extracting an image region corresponding to at least one body part, such as a hand, arm, or face, from the motion image information.

The term “motion-region cropping” refers to cutting out a subregion of an image that contains a detected gestural movement while excluding background or irrelevant areas.

The term “motion-interval segmentation” refers to determining temporal boundaries that divide motion image information into intervals, each interval corresponding to a unit of gestural movement such as a sign or phrase.

The term “machine learning model” refers to a computational model that has been trained using data to perform recognition or prediction tasks, including but not limited to neural networks, statistical models, and other learned classifiers.

The term “body joint position information” refers to numerical data indicating estimated positions of anatomical key points of a body, such as joints of hands, arms, shoulders, or other relevant body parts, in one or more images.

The term “character-string information” refers to digital text data composed of one or more characters or symbols that represent semantic content in a written form.

The term “semantic content” refers to the meaning or information conveyed by a gestural movement, including an intent, word, phrase, or sentence that can be expressed in natural language.

The term “prompt sentence” refers to a text instruction or query provided to a generative AI model to specify a generation task, constraints, or context for producing character-string information.

The term “generative AI model” refers to an information processing model configured to generate character-string information, such as a natural-language model that produces text in response to a prompt sentence.

The term “natural-language sentence form” refers to character-string information structured according to grammatical and syntactic rules of a human language so as to be interpretable as a sentence.

The term “speech synthesis processing unit” refers to a hardware or software component configured to convert character-string information into audio data by generating audio parameters and speech feature values.

The term “audio parameters” refers to numerical values representing control attributes used in speech synthesis, including at least pitch, duration, intensity, and spectral characteristics.

The term “speech feature values” refers to numerical representations of characteristics of a synthesized speech signal, including at least spectral coefficients, prosodic features, and timing features.

The term “audio data” refers to digital information representing sound, including a sequence of samples or encoded audio frames that can be converted into physical sound.

The term “communication path” refers to a wired or wireless communication link or network through which data can be transmitted between the system and a terminal device.

The term “terminal device” refers to an electronic device separate from the server that is capable of receiving audio data via the communication path and outputting the audio data as physical sound, such as a mobile device, a personal computer, or a dedicated terminal.

The term “acoustic output device” refers to a device configured to convert audio data into physical sound, such as a speaker, headphone, or earphone.

The term “expression information” refers to data representing at least a facial expression of a user, including images, video frames, or extracted facial features used for emotion estimation.

The term “voice information” refers to audio data representing vocal sounds of a user, including spoken utterances, from which features for emotion estimation can be derived.

The term “emotional state” refers to an internal affective condition of a user, such as happiness, sadness, anger, or neutrality, inferred from expression information or voice information.

The term “intonation parameter” refers to a control value used in speech synthesis to represent prosodic characteristics, including pitch contour and emphasis pattern, associated with an emotional state.

The term “voice-quality parameter” refers to a control value used in speech synthesis to represent timbral or stylistic characteristics of a voice, such as breathiness, brightness, or roughness, associated with an emotional state.

The term “body-part position estimation processing” refers to processing that estimates spatial positions of body parts within an image, including detection and localization of joints or key points.

The term “motion-feature extraction processing” refers to processing that derives descriptive features from motion image information, including changes in body-part positions, trajectories, or temporal patterns of movement.

In one embodiment, a server implements a sign-language-to-speech conversion system that is configured in accordance with the above claims. The server includes at least one processor, a memory, a storage device, a network interface, and an interface to an image acquisition device. The server is connected, via a wired or wireless network, to at least one terminal. The terminal includes at least one processor, a memory, a network interface, and an acoustic output device such as a loudspeaker or headphones.

The server uses a general-purpose operating system, for example a Linux-based operating system, and executes application software implemented, for example, in a high-level programming language such as Python or C++. The server executes libraries for image processing and numerical computation, such as a computer-vision library (for example, a library including functions equivalent to OpenCV), and a numerical-computation library (for example, a library including functions equivalent to NumPy). The server also executes a machine learning framework, such as a framework including functions equivalent to PyTorch or TensorFlow, for running neural network models. The server further executes a natural language processing library, such as a library including functions equivalent to spaCy or a transformer-based language model framework, and a client library for accessing a text-to-speech service. The server optionally uses a hardware accelerator, such as a graphics processing unit, to speed up the execution of neural network models.

The server connects to the image acquisition device, which may be a high-resolution digital camera, a depth camera, or a multi-camera array. The server configures the image acquisition device to capture motion image information that includes gestural movement performed by a user. The gestural movement typically consists of sign language gestures formed by hands, arms, and upper body, but may include other body parts or facial expressions. The server receives the motion image information as a time-ordered sequence of frames and stores the frames in the memory using a defined data structure, for example, a ring buffer that maintains a fixed number of the most recent frames.

The server performs preprocessing of the motion image information to create data structures that are suitable for machine learning-based recognition. The server resizes each frame to a fixed spatial resolution required by a recognition model, for example 224×224 pixels, and normalizes pixel values into a predefined range, such as [0,1] or a zero-mean, unit-variance distribution. The server applies body-part region extraction by using a pose-estimation algorithm, for example an algorithm equivalent to a multi-stage convolutional neural network that outputs heatmaps of joint locations. The server converts the heatmaps into explicit body joint position information by computing the coordinates of local maxima in the heatmaps and stores those coordinates as arrays of numerical values.

The server then performs motion-region cropping. Based on the body joint position information, the server calculates a bounding region that encloses the hands and forearms or other relevant body parts. The server extracts, from each frame, an image patch corresponding to this region and discards unrelated background regions. The server uses a specific bounding-box expansion margin to ensure that the full gesture is captured even when the hands move quickly. The server further performs motion-interval segmentation. To accomplish this, the server computes motion features, such as frame-to-frame differences of joint coordinates and optical flow magnitude in the cropped region. The server then calculates a motion energy signal as a function of time and applies a thresholding algorithm with hysteresis to detect intervals of significant motion. In this way, the server segments the continuous frame stream into discrete motion intervals, each interval representing a candidate gesture or phrase.

The server represents each motion interval using a structured time-series data object. In one example, the server constructs a tensor whose dimensions correspond to time steps, keypoint indices, and coordinate values. The server may also include additional channels for derived features, such as joint velocities and accelerations. This structured representation is more compact and informative than raw pixel data and reduces the amount of data processed by subsequent models, thereby improving computational efficiency and reducing memory bandwidth usage.

The server inputs the structured time-series data into a machine learning model for recognition. In one embodiment, the server uses a neural network composed of a spatial feature-extraction backbone and a temporal sequence-processing component. The spatial backbone can be a convolutional neural network that receives cropped image patches or joint-heatmap images and outputs feature vectors for each time step. The temporal component can be a recurrent architecture, such as a bidirectional long short-term memory network, or a self-attention-based architecture such as a transformer encoder that consumes the sequence of feature vectors. The server configures hyperparameters such as the number of layers, hidden units, attention heads, and dropout rates based on accuracy and latency requirements.

The server trains the machine learning model in advance using a training dataset that includes many examples of gestural movements paired with ground-truth labels representing semantic content. During training, the server uses a loss function, such as a cross-entropy loss, to measure the difference between predicted class probabilities and the ground-truth labels. The server updates weights of the neural network by using a gradient-based optimization algorithm, such as stochastic gradient descent or an adaptive optimizer, and may apply data augmentation methods, such as random spatial cropping, temporal scaling, or joint-coordinate perturbation, to increase robustness. As a result, the trained model learns patterns of movement that are not easily described by explicit human-crafted rules and can recognize gestures with high accuracy under varied lighting and viewpoints.

At run time, the server feeds the time-series data into the trained neural network and obtains a probability distribution over possible gesture classes. The server uses a decision rule, such as an argmax selection or beam search over class sequences, to determine recognized character-string information corresponding to the semantic content of the gestural movement. The server calculates a confidence score, for example by taking the maximum class probability or by computing a log-likelihood. The server may discard or reprocess intervals whose confidence score falls below a predetermined threshold, thereby reducing erroneous outputs and improving effective accuracy.

The server converts the recognized class label into base character-string information in a target natural language. In one simple case, the server uses a mapping table between gesture classes and canonical text phrases. In a more advanced case, the server uses a decoding algorithm that combines class probabilities with a language model to select the most probable sequence of words. The server then refines the base character-string information into a natural-language sentence form by using a generative AI model.

The server interacts with the generative AI model by preparing a prompt sentence that specifies the recognition result and a generation instruction. For example, the server can use the following prompt sentence:

“Input: Sign language phrase recognized as ‘Thank you.’.

Task: Convert this into a polite, natural Japanese sentence suitable for spoken output.”

The server transmits this prompt sentence to the generative AI model, which can be implemented locally using a transformer-based language model or accessed via a network-based API. The server provides the recognized phrase and optional context, such as conversation history, speaker role, or formality level, as structured input tokens. The generative AI model then generates character-string information in a natural-language sentence form, such as “Thank you very much.”. The server constrains generation by specifying maximum output length, decoding strategy (for example, beam search or nucleus sampling), and token-level penalties for repetition. By using the recognition result as a conditioning signal and by explicitly specifying the task in the prompt sentence, the system produces output that is both faithful to the gesture and linguistically natural.

The use of the generative AI model improves computer technology in several ways. First, the server offloads language-specific post-processing from rigid rule-based scripts to a statistical sequence model that can handle diverse linguistic patterns, which simplifies the overall software architecture and reduces the need for extensive manual grammar engineering. Second, by structuring the interaction around explicit prompt sentences, the server can change linguistic style, domain, or politeness level without retraining the recognition model, thereby increasing flexibility and reducing maintenance cost. Third, the generative model can be configured to run in a streaming or incremental fashion, allowing partial sentence generation while the gesture is still being recognized, which reduces end-to-end latency.

The server then converts the natural-language character-string information into audio data. The server transmits the character-string information to a speech synthesis processing unit. The speech synthesis processing unit may be implemented as a local neural text-to-speech model or as an external service accessible via a network. The server provides parameters such as language code, desired voice type, speaking rate, and volume level. The speech synthesis processing unit converts text into a sequence of acoustic feature vectors, such as mel-spectrogram frames, and then into time-domain waveform samples. The server may use a neural vocoder model, such as a generative adversarial network-based or autoregressive model, to generate high-quality waveform data from the acoustic features.

The server enhances the speech synthesis by incorporating emotion-related parameters. To obtain these parameters, the server acquires expression information or voice information of the user, for example from the same image acquisition device or from a microphone. The server extracts features such as facial action unit intensities, prosodic patterns, or spectral characteristics and applies an emotion-classification model, which may be a neural network trained on labeled emotion datasets. Based on the estimated emotional state, the server selects or adjusts intonation parameters and voice-quality parameters, such as pitch contour scaling, speaking rate modification, and spectral tilt. The server then passes these parameters to the speech synthesis processing unit, which generates audio data whose prosody and timbre are adapted to the emotional state. This dynamic control is not a simple automation of human reading, but a computational improvement that links multimodal inputs to parametric control of synthetic speech, improving intelligibility and expressiveness.

The server transmits the generated audio data to the terminal via a communication path. The server may segment the audio data into frames or packets and stream them using a real-time protocol. The server includes sequence numbers and timestamps in the packet headers to ensure correct order and stable playback. The use of segmented streaming allows the terminal to start playback before the entire utterance has been synthesized, reducing perceived latency and improving the responsiveness of the system.

The terminal receives the audio data and reconstructs the audio stream. The terminal buffers a small portion of the stream to absorb network jitter and decodes the audio data into raw waveform samples if a compressed format is used. The terminal then supplies the samples to the acoustic output device using an audio driver that converts digital values into analog signals. The terminal may be a smartphone, a tablet, a laptop, or a dedicated device installed in a meeting room or public facility. In each case, the terminal only needs limited processing capabilities, because most of the computationally intensive processing is performed by the server.

The user who is a deaf or hard-of-hearing person stands or sits within the field of view of the image acquisition device and performs sign language gestures. The user does not need to wear special markers or gloves, because the server uses body-part position estimation to detect hands and arms directly from the video. The user who is a hearing person listens to the speech output from the terminal and responds through ordinary spoken language. This configuration enables real-time or near-real-time communication between the users.

The described system provides technical improvements over conventional approaches. By representing motion as structured time-series joint data and motion features, the server reduces the dimensionality of the input and focuses computation on relevant regions, which leads to faster inference and lower communication load between modules. By using explicit motion-interval segmentation with hysteresis-based thresholding on motion energy, the server avoids unnecessary processing of non-gesture frames and improves temporal alignment between gesture units and linguistic units, which reduces recognition errors. By using a neural network architecture that jointly models spatial and temporal patterns, the server achieves higher accuracy than systems that treat each frame independently. By integrating generative AI-based text refinement via carefully designed prompt sentences, the server produces outputs that are better aligned with natural conversational usage, which cannot be easily achieved by simple template-based systems. The server thus improves how the computer processes multimodal information rather than merely automating a human interpreter.

Alternative embodiments are also possible. The server may use different types of image acquisition devices, such as depth cameras that provide three-dimensional joint coordinates, which further enhance robustness under varying lighting. The server may use alternative neural network architectures, such as graph convolutional networks that operate directly on body joint graphs, or temporal convolutional networks that use dilated convolutions over time. The server may integrate a local generative AI model that runs entirely on the server hardware, thereby avoiding reliance on external services and enabling operation in offline environments. The terminal may be implemented as a web browser application, a native mobile application, or an embedded system. The speech synthesis processing unit may be integrated into the server or into the terminal, depending on network conditions and hardware capabilities.

In another embodiment, the server processes multiple users simultaneously by allocating separate buffers and recognition pipelines for different regions of the image or by associating body joint tracks with particular users. The server can also log recognized character-string information and corresponding audio data for later analysis, system improvement, or personalization of recognition models. The server can update model parameters periodically using additional training data collected during use, employing incremental learning methods that adjust weights without catastrophic forgetting.

Through these configurations, the system is not limited to abstract data processing but directly controls and coordinates concrete devices, including cameras and speakers, and achieves technical effects such as improved recognition accuracy, reduced latency, reduced bandwidth usage, and enhanced quality of synthesized speech. The system thus constitutes a specific improvement in the functioning of computers used for multimodal communication and provides a practical application of generative AI models and prompt sentences in sign-language processing.

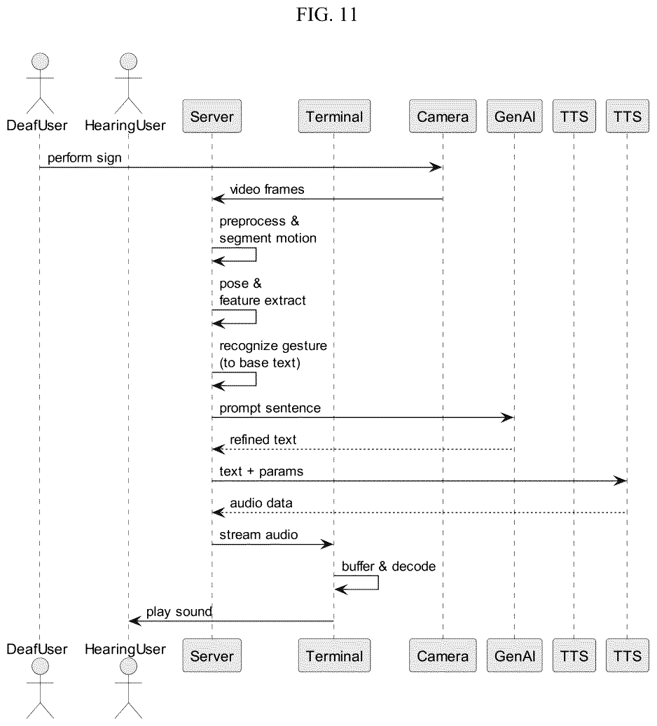

The following describes the processing flow using FIG. 11.

Step 1:

Server initializes hardware and software resources.

Server loads configuration data from storage, including camera parameters, neural network model paths, generative AI model access settings, text-to-speech settings, and threshold values for motion detection and recognition confidence.

Server initializes an image acquisition device by setting frame rate, resolution, exposure, and color format, and opens a continuous capture stream.

Server loads a pre-trained pose-estimation model and a sign-language recognition model into memory, and if available, transfers model weights to a graphics processing unit to accelerate computation.

Input: configuration files, model files, and device drivers.

Output: initialized camera handle, loaded neural network models in memory, and runtime parameters stored in working memory.

Based on these inputs, server assigns memory buffers, creates data structures for frame queues and motion intervals, and prepares API clients for the generative AI model and text-to-speech engine.

Step 2:

Server acquires raw motion image information.

Server continuously reads frames from the image acquisition device and stores each frame as a digital image in a frame buffer.

Server attaches a timestamp to each frame and assigns a frame index to maintain chronological order.

Input: optical image signals captured by the image acquisition device.

Output: a sequence of raw frames stored as arrays of pixel values with associated timestamps.

Using these inputs, server converts analog sensor data into digital image data and organizes it into a time-series structure suitable for further processing, such as a ring buffer that discards the oldest frame when the buffer is full.

Step 3:

Server performs frame-level preprocessing.

Server resizes each raw frame to a fixed width and height required by subsequent models, and converts color channels into a standard format, such as RGB or grayscale.

Server normalizes pixel values by scaling them into a predetermined numerical range or by subtracting mean and dividing by standard deviation computed from training data.

Input: raw frames with original resolution and color format.

Output: normalized, resized frames represented as numerical arrays with consistent dimensions.

Based on these inputs, server executes mathematical operations on each pixel (multiplication, addition, division) to generate standardized images that reduce variance due to differing camera settings and lighting conditions.

Step 4:

Server executes body-part position estimation and motion-region extraction.

Server feeds each preprocessed frame into a pose-estimation model that outputs probability maps or keypoint coordinates for body joints such as wrists, elbows, shoulders, and facial landmarks.

Server calculates joint positions by locating local maxima in probability maps or directly reading regression outputs from the pose-estimation model.

Server determines a bounding region that encloses relevant joints (for example, both hands and forearms) and crops this region from the frame as a motion region.

Input: preprocessed frames.

Output: body joint position information for each frame and cropped motion-region images.

From these inputs, server performs statistical inference using the pose-estimation neural network, then computes bounding boxes using coordinate geometry (minimum and maximum of joint coordinates plus margins) to reduce irrelevant background and focus subsequent processing on the gesture area.

Step 5:

Server performs motion-interval detection and segmentation.

Server computes motion features across successive frames, such as differences in joint positions, velocities, and accelerations, and optionally optical flow magnitudes inside motion regions.

Server aggregates these features over time to form a motion energy signal and applies thresholding with hysteresis to determine periods of significant movement.

Server marks the start of a motion interval when the motion energy exceeds a high threshold and marks the end when the energy falls below a lower threshold for a predetermined number of frames.

Input: body joint position information and cropped motion-region images over a sequence of frames.

Output: identified motion intervals, each defined by a start frame index and an end frame index, along with associated frame sequences.

Using these inputs, server executes numerical differentiation, absolute value operations, summations, and threshold comparisons to isolate segments that likely correspond to complete signs or phrases, thereby reducing the volume of data that needs to be classified by the recognition model.

Step 6:

Server constructs structured time-series data for recognition.

Server collects all frames and corresponding joint coordinates within each motion interval and organizes them into a fixed-size or variable-length tensor representation.

Server may interpolate or sample frames to match a standard number of time steps, and may compute additional features such as joint angles and relative positions between joints.

Input: motion intervals with associated frame ranges and joint coordinate sequences.

Output: time-series data objects (for example, tensors) representing each motion interval in terms of joint coordinates and derived features.

Based on these inputs, server generates a compact, structured representation where each element of the tensor encodes spatial and temporal aspects of the gesture, enabling efficient input into the sign-language recognition model.

Step 7:

Server performs sign-language recognition using a neural network.

Server inputs each time-series data object into the sign-language recognition model, which may consist of a spatial feature extractor followed by a temporal sequence model.

Server executes matrix multiplications, non-linear activations, and other neural network operations layer by layer to produce a feature sequence and finally a probability distribution over gesture classes or phrases.

Server selects one or more candidate class labels using a decision procedure such as argmax or beam search, and computes a confidence score for each candidate.

Input: structured time-series data describing motion intervals.

Output: recognized base character-string information (for example, a short phrase) and associated confidence scores.

Using these inputs, server applies learned weight matrices and biases that were obtained during training, propagating activations through network layers to infer the most likely semantic content of the gestural movement.

Step 8:

Server filters and validates recognition results.

Server compares each confidence score with a predefined threshold and discards recognition results whose confidence is below the threshold.

Server may merge consecutive low-variation intervals or request additional frames if motion appears incomplete, to improve reliability.

Input: base character-string information and confidence scores from the recognition model.

Output: validated base character-string information for intervals that meet confidence requirements, and optional flags for intervals requiring reprocessing or user confirmation. From these inputs, server performs logical comparisons and control-flow decisions, ensuring that only sufficiently confident recognition results proceed to language refinement and speech synthesis.

Step 9:

Server generates a prompt sentence for a generative AI model.

Server constructs a natural-language instruction that includes at least the recognized base character-string information and a description of the desired output style.

Server formats the prompt sentence as plain text, for example:

“Input: Sign language phrase recognized as ‘Thank you.’.

Task: Convert this into a polite, natural Japanese sentence suitable for spoken output.”

Server may append contextual information such as speaker role, level of formality, or conversation topic.

Input: validated base character-string information and optional context data.

Output: a prompt sentence represented as a text string, ready to be supplied to the generative AI model.

Using these inputs, server concatenates fixed instruction templates with variable parts (recognized phrase and context) to generate a well-structured prompt that guides the generative AI model toward generating appropriate natural-language sentences.

Step 10:

Server refines text using a generative AI model.

Server sends the prompt sentence to a generative AI model implemented as a transformer-based language model, either locally or via a network interface.

Server receives token-by-token or sequence-level output from the generative AI model and decodes token IDs into characters or words to obtain a natural-language sentence.

Server may apply post-processing such as trimming whitespace, enforcing maximum length, or adjusting punctuation.

Input: prompt sentence text.

Output: refined natural-language character-string information, such as a complete polite sentence.

Based on this input, server leverages the generative AI model's internal attention mechanisms and learned language patterns to produce text that is more natural and contextually appropriate than the base character-string information, while still faithful to the recognized gesture.

Step 11:

Server estimates user emotion and determines speech parameters.

Server acquires expression information from the image acquisition device or voice information from a microphone, synchronized with the motion interval.

Server extracts features such as facial landmark movements, prosodic contours, or spectral coefficients and inputs these features into an emotion-classification model.

Server determines an emotional state (for example, neutral, happy, or sad) and maps the emotional state to numerical intonation parameters and voice-quality parameters, including pitch scaling, speaking rate adjustments, and timbre modifications.

Input: expression information and/or voice information corresponding to the user.

Output: estimated emotional state and associated speech-parameter values.

Using these inputs, server performs feature extraction and classification to produce control parameters that will influence the prosody and tone of the synthesized speech, thereby enhancing expressiveness.

Step 12:

Server synthesizes audio data from the refined text.

Server transmits the refined natural-language character-string information and the determined speech parameters to a speech synthesis processing unit.

Server causes the speech synthesis processing unit to convert the text into intermediate acoustic features such as mel-spectrograms and then into waveform samples, optionally using a neural vocoder.

Server encodes the waveform into an audio format, such as linear PCM or a compressed format, suitable for transmission to the terminal.

Input: refined natural-language character-string information and speech-parameter values.

Output: audio data representing the spoken version of the refined sentence.

Using these inputs, server executes algorithms that map textual units to phonetic sequences, generate time-aligned acoustic features, and synthesize waveforms that reflect both the linguistic content and the emotion-adjusted prosody.

Step 13:

Server transmits audio data to the terminal.

Server divides the audio data into packets or chunks and attaches metadata such as sequence numbers, timestamps, and language indicators.

Server sends the packets over a communication path using a network protocol, for example a streaming protocol over a reliable transport layer.

Server may start transmitting as soon as a sufficient initial portion of audio data is available, enabling the terminal to begin playback while remaining portions are still being transmitted.

Input: synthesized audio data and control metadata.

Output: a sequence of audio packets delivered to the terminal through the network interface. From these inputs, server performs data segmentation, header construction, and network transmission operations, ensuring orderly, low-latency delivery of the audio stream.

Step 14:

Terminal receives, buffers, and decodes audio data.

Terminal listens on a network socket or application-level connection and receives the audio packets from the server.

Terminal checks sequence numbers and timestamps to reorder packets if necessary, and stores the data in a playback buffer.

Terminal decodes the audio data if a compressed format is used, converting it into raw waveform samples ready for playback.

Input: audio packets and associated metadata from the server.

Output: buffered, ordered, and decoded audio samples stored in terminal memory.

Using these inputs, terminal executes buffer management routines, error checking, and decoding algorithms to reconstruct a continuous audio stream from network-delivered fragments.

Step 15:

Terminal outputs physical sound to the user.

Terminal supplies the decoded waveform samples to the acoustic output device using an audio driver provided by the operating system.

Terminal controls volume, balance, and, if necessary, channel routing, and causes the acoustic output device to generate corresponding sound waves.

Input: decoded audio samples.

Output: physical sound waves perceptible to a hearing user.

Based on these inputs, terminal converts digital numerical samples into analog electrical signals, which the acoustic output device transforms into audible sound, allowing the hearing user to perceive the content of the original sign language.

Step 16:

User interacts with the system during communication.

User who is a deaf or hard-of-hearing person positions themself within the field of view of the image acquisition device and performs sign language gestures as part of a conversation.

User who is a hearing person listens to the speech output from the terminal and responds with spoken language or other actions.

User may adjust their position, gesture speed, or facial expression based on feedback from the system's responsiveness and accuracy.

Input: visual feedback from the environment and auditory feedback from the terminal (for the hearing user).

Output: gestural movement and facial expressions captured by the image acquisition device, and spoken responses captured by microphones or perceived by humans.

Through these interactions, user supplies new motion image information and contextual signals to the server, closing the communication loop and enabling continuous, real-time use of the sign-language-to-speech conversion system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional sign-language translation systems often rely on fixed pattern recognition and direct mapping from visual features to text, without effectively leveraging generative models or structured prompting. As a result, such systems suffer from low robustness to variations in signing style, limited adaptability to new expressions, and unnatural or unpolished output sentences that are poorly suited for spoken interaction in real-world environments such as physical stores. Moreover, conventional systems typically treat recognition, language generation, and speech synthesis as isolated components, lacking a coordinated mechanism to refine intermediate text representations and to continuously improve recognition accuracy based on accumulated usage data.

From a computer-technology perspective, there is a need for improved processing architectures that (i) segment continuous sign-language video streams into meaningful temporal sections, (ii) convert low-level body-part feature information into higher-level symbolic representations, (iii) use generative AI models through explicitly constructed prompt sentences to transform these symbolic representations into natural-language text, and (iv) iteratively refine the generated text into speech-ready expressions. There is also a need for systems that systematically log multimodal information (image information, text information, acoustic information, and user evaluation information) and use this log information to update both recognition algorithms and prompt-design strategies, thereby improving the overall performance of the human-computer interface over time.

Without such an integrated approach, computer systems remain limited in their ability to provide accurate, context-appropriate, and polite spoken output based on sign-language input, particularly under real-time constraints and diverse usage conditions. Accordingly, there is a demand for a computer-implemented technique that improves the underlying information processing—segmentation, feature extraction, prompt-based generative processing, text formatting, and adaptive learning—rather than merely automating a human translation workflow.

The specific processing by the specific processing unit 290 of the data processing device 12 in Application Example 1 is realized by the following means.

The present invention provides a server comprising a processor configured to acquire image information including sign-language motion from an imaging apparatus, perform preprocessing to extract a region including the sign-language motion, and segment the image information into temporal sections based on a start and an end of the sign-language motion; to extract body-part feature information from the image information for each temporal section, generate a symbol sequence corresponding to a sign-language expression based on the feature information, generate a first prompt sentence including the symbol sequence and associated auxiliary information, and input the first prompt sentence to a generative AI model to cause the generative AI model to generate natural-language text information; to generate a second prompt sentence for performing notation-unification processing and style-conversion processing on the natural-language text information, input the second prompt sentence to the generative AI model to generate formatted text information suitable for speech, input the formatted text information to a speech-generation processing unit to convert the formatted text information into acoustic information, and output the acoustic information in real time via an output device; to display the formatted text information on a display device and control execution of conversion processing into the acoustic information or execution of re-input processing based on a confirmation operation from a user; and to store, in association, at least the image information, the natural-language text information, the formatted text information, the acoustic information, and evaluation information from the user as log information, and to generate learning data for improving sign-language-motion recognition processing and prompt-sentence design based on the log information. This enables a computer-centric improvement of sign-language translation processing by introducing structured temporal segmentation, feature-based symbolic representation, multi-stage prompt-driven generative text processing, and feedback-based adaptive learning, thereby enhancing recognition accuracy, naturalness, and suitability of the generated speech for real-time human interaction.

The term “processor” refers to a hardware or virtual information processing unit, such as a central processing unit or an execution core, that executes instructions to perform the functions described for the system.

The term “imaging apparatus” refers to an electronic device capable of capturing image information as still images or moving images, such as a camera or an image sensor module.

The term “image information” refers to digital data representing visual content, including sequences of image frames or video streams that may contain sign-language motion.

The term “sign-language motion” refers to a series of movements and configurations of body parts, including hands, arms, and facial regions, that represent linguistic expressions in a sign language.

The term “preprocessing” refers to computational operations performed on raw image information prior to recognition, including but not limited to color conversion, resizing, normalization, region-of-interest extraction, noise reduction, and temporal segmentation.

The term “region including the sign-language motion” refers to a spatial portion of the image information that contains the body parts involved in sign-language expression, such as hands and upper body, extracted for focused analysis.

The term “temporal sections” refers to subdivided time intervals of the image information, each interval corresponding to at least part of a sign-language expression between a detected start and end of sign-language motion.

The term “body-part feature information” refers to numerical or symbolic descriptors derived from the image information that represent positions, shapes, or movements of body parts, such as keypoints, vectors, or posture parameters.

The term “symbol sequence” refers to an ordered set of symbols or tokens that abstractly represent identified sign-language units, such as glosses, labels, or intermediate linguistic codes derived from the body-part feature information.

The term “sign-language expression” refers to a meaningful linguistic unit, such as a word, phrase, or sentence, expressed by one or more sign-language motions.

The term “auxiliary information” refers to additional data associated with the symbol sequence, such as timing information, confidence scores, contextual tags, or metadata that support subsequent processing.

The term “prompt sentence” refers to a text string provided as input to a generative AI model, instructing or guiding the model to perform a specific information processing task, such as generating, correcting, or formatting text.

The term “generative AI model” refers to a computational model, such as a neural network-based language model, configured to generate output data, including text, based on input data and learned parameters.

The term “natural-language text information” refers to textual data composed in a human language, such as a sentence or phrase understandable by a human user, generated as an interpretation of the sign-language expression.

The term “notation-unification processing” refers to processing that standardizes written forms in text, including operations such as normalizing capitalization, spelling, numerals, punctuation, and abbreviations.

The term “style-conversion processing” refers to processing that modifies the tone, politeness level, or stylistic characteristics of text, such as converting casual expressions into polite expressions suitable for spoken communication.

The term “formatted text information” refers to natural-language text information that has undergone notation-unification processing and style-conversion processing and is adjusted for direct use in speech synthesis.

The term “speech-generation processing unit” refers to a hardware or software component configured to convert text information into acoustic information, such as a text-to-speech engine.

The term “acoustic information” refers to digital data representing sound, including audio signals suitable for playback by an audio output device.

The term “output device” refers to a component that presents acoustic information to a user in an audible form, such as a loudspeaker or headphone.

The term “real time” refers to processing and output operations performed with sufficiently low latency such that a user perceives the response as occurring substantially without delay.

The term “display device” refers to a hardware component capable of visually presenting text or other visual information, such as a monitor, screen, or display panel.

The term “conversion processing” refers to operations that transform text information into acoustic information, including text-to-speech synthesis and any associated signal processing.

The term “re-input processing” refers to operations that permit a user to provide new or revised input, such as re-performing a sign-language motion, in response to an indication that the previous processing result is unsatisfactory.

The term “user” refers to a person who provides sign-language motion or other input to the system and who may confirm, accept, or reject system outputs.

The term “log information” refers to stored data records that include at least image information, natural-language text information, formatted text information, acoustic information, and user evaluation information, used for analysis and improvement of system performance.

The term “evaluation information” refers to data representing a user's assessment of system output quality, such as explicit feedback, ratings, or selection inputs indicating correctness or appropriateness.

The term “learning data” refers to processed or curated data derived from log information and other sources, used to train or update recognition algorithms, generative models, or prompt designs.

The term “sign-language-motion recognition processing” refers to processing that identifies and interprets sign-language motion in image information, including extraction of body-part feature information and generation of symbol sequences.

The term “text-information generation processing” refers to processing that produces natural-language text information from intermediate representations, including symbol sequences and outputs of the generative AI model.

The term “prompt-sentence design” refers to selection, construction, and modification of prompt sentences provided to a generative AI model to control or improve the quality, style, or accuracy of generated outputs.

In an embodiment, a server executes a sign-language translation program on one or more processors, such as a multi-core central processing unit and, optionally, a graphics processing unit. The server operates under an operating system such as a UNIX-like system and communicates with a terminal over a network. The server connects to an imaging apparatus such as a digital camera or an image sensor module installed in a physical environment, for example near a counter in a store. The server further communicates with one or more external text-to-speech services and, optionally, with external generative AI model services over a communication network.

The server uses an imaging apparatus to obtain image information representing sign-language motion of a user. The server receives a continuous stream of frames encoded in a format such as YUV or RGB and converts the frames into an internal representation using an image processing library such as a general-purpose vision library. The server stores the frames in a frame buffer implemented in main memory. The server uses hardware acceleration provided by a graphics processing unit to perform convolution, normalization, and region-of-interest extraction on the frames.

The server applies a pose-estimation model to each frame to detect body-part keypoints, including positions of hands, wrists, elbows, shoulders, and facial landmarks. The server may implement the pose-estimation model using a neural-network framework such as a tensor-based computation library. The server configures the pose-estimation model as a deep neural network with multiple convolutional layers, batch-normalization layers, and activation layers, followed by a keypoint regression head. The server inputs a resized and normalized frame tensor of shape, for example, (T, H, W, C) where T is a temporal window size, H and W are spatial dimensions, and C is the number of channels, and obtains a set of 2D or 3D coordinates for each detected joint.

The server computes body-part feature information based on the detected keypoints. The server calculates relative positions of keypoints, bone-length normalization, joint angles, velocities, and accelerations across consecutive frames. The server organizes the feature information into a time-series data structure, for example, a sequence of feature vectors of fixed dimension per time step. The server stores this sequence in a structured array or tensor in memory. The server detects a start and an end of sign-language motion by analyzing temporal changes of the feature vectors. For example, the server computes a motion energy measure by summing squared velocities of hand keypoints and compares the measure with a threshold. When the motion energy rises above a start threshold and later falls below an end threshold for a specified duration, the server defines a temporal section of sign-language motion.

The server converts the time-series feature information in each temporal section into a symbol sequence representing a sign-language expression. In one embodiment, the server uses a sequence model such as a recurrent neural network, a temporal convolutional network, or a transformer-based encoder. The server configures the sequence model with an input layer that accepts the feature vectors, multiple intermediate layers that learn temporal dependencies, and an output layer that produces a sequence of discrete tokens corresponding to glosses or intermediate sign units. The server trains the sequence model using a loss function such as cross-entropy or an alignment-based loss, and uses gradient descent and backpropagation to update the model parameters. The server may apply data augmentation to training data, such as random temporal scaling, spatial jittering of keypoints, and noise injection, to improve robustness to different users and signing speeds.

The server generates a symbol sequence such as “PRODUCT/INFORMATION/REQUEST” along with auxiliary information including timing markers, confidence scores, and user-specific identifiers. The server constructs a prompt sentence in a natural language for a generative AI model. The server embeds the symbol sequence and auxiliary information into the prompt sentence according to a predefined template stored in memory. For example, the server constructs a prompt sentence such as:

“The following is a sequence of sign-language tokens representing a customer's request in a shop. Convert these tokens into one polite, natural sentence in English that could be spoken aloud: PRODUCT/INFORMATION/REQUEST.”

The server provides the prompt sentence as input to a generative AI model. In one embodiment, the server accesses an external generative AI model service that hosts a large language model implemented as a transformer network with multiple attention layers and feed-forward layers. The server transmits the prompt sentence via a network protocol such as HTTPS and receives generated natural-language text information as a response. In another embodiment, the server runs a generative AI model locally on a graphics processing unit, storing model parameters such as attention weights and layer normalization statistics in memory.

The server obtains natural-language text information from the generative AI model, for example, “Please tell me about this product.” The server then performs notation-unification processing and style-conversion processing. The server constructs a second prompt sentence to further refine the text, for example:

“Rewrite the following sentence so that it is polite and natural when spoken by a customer to a store clerk in English. Keep the meaning the same and output only the corrected sentence: ‘Please tell me about this product.’”

The server inputs the second prompt sentence to the generative AI model and receives formatted text information suitable for speech, for example, “Could you please tell me about this product?” In another embodiment, the server may apply local natural-language processing components, such as rule-based token normalization and grammar-correction models, in combination with or instead of the generative AI model to perform notation unification and style conversion.

The server provides the formatted text information to a speech-generation processing unit. In one embodiment, the server accesses an external text-to-speech service implemented on a remote computing system. The server configures text-to-speech parameters such as language, voice type, speaking rate, and pitch. The server transmits the formatted text information and the parameters to the text-to-speech service and receives acoustic information in an audio format such as pulse-code modulation. The server may use an audio-processing library to adjust the amplitude, remove silence, or convert sample rates. The server then transmits the acoustic information to the terminal over a streaming protocol such as WebSocket.

The terminal is realized as a smart device such as a smartphone or tablet. The terminal comprises a network interface, a display device, an audio output device such as a loudspeaker, and input interfaces such as a touch screen. The terminal receives acoustic information from the server, buffers the data in a ring buffer structure in memory, and decodes the audio using an operating system audio API. The terminal outputs the acoustic information via the audio output device so that a hearing person can listen to the spoken representation of the sign-language input.

The terminal also receives the formatted text information from the server and presents it on the display device. The terminal renders the text and provides user interface elements such as confirmation and retry buttons. The terminal sends the user's confirmation or rejection as a control message to the server. When the user confirms the text, the server proceeds with or has already completed the conversion to acoustic information. When the user rejects the text, the server discards or flags the corresponding data and may prompt the user to perform the sign-language motion again.

The user performs sign-language motion in a capture area visible to the imaging apparatus. The user may hold or position the terminal to view the preview video and the formatted text. The user confirms or rejects the translation result by touching the terminal's display. The user may also provide explicit evaluation information such as a rating or a comment via an on-screen control.

The server stores log information in a storage device such as a relational database or a key-value store. The log information includes image information, symbol sequences, auxiliary information, natural-language text information, formatted text information, acoustic information, user confirmation or rejection signals, and evaluation information. The server associates these data with time stamps and session identifiers. The server periodically extracts learning data from the log information. For example, the server may pair initial natural-language text information with formatted text information and user confirmations, thereby creating supervision for training or fine-tuning generative models and for improving prompt-sentence design.

The server uses the learning data to update parameters of the sequence model that maps body-part feature information to symbol sequences. The server trains the model using stochastic gradient descent, minimizing a loss function that reflects errors between predicted symbol sequences and corrected symbol sequences derived from user-confirmed outputs. The server also updates prompt templates and prompt content based on success rates recorded in the log information. For example, if certain prompt patterns produce more user-approved outputs, the server increases a selection probability or ranking of those patterns in future processing.

The server thus improves recognition accuracy and text quality over time by adjusting model parameters and prompt-sentence design in response to real usage data. Because the server uses structured temporal segmentation, feature extraction, and symbol-sequence representation, the server reduces the amount of raw image information that must be processed at later stages. This reduction in data dimensionality leads to improved computational efficiency and reduced communication load between the server and external model services. The server further achieves latency reduction by segmenting sign-language motion into temporal sections and processing each temporal section incrementally, so that partial results can be generated and confirmed before an entire conversation is completed.

The server achieves technical advantages compared to a direct frame-to-text mapping approach. The intermediate representation in the form of symbol sequences allows the server to reuse generative AI models trained on text and to decouple visual recognition from linguistic generation. As a result, the server can adjust symbol-to-text behavior by modifying prompt sentences without retraining the entire visual model, which leads to improved maintainability and adaptability. The server's use of multi-stage prompt sentences—first to transform symbol sequences into rough natural-language text, and second to perform notation unification and style conversion—enables a kind of layered language processing that improves evaluation metrics such as fluency and politeness, while maintaining control over how the generative AI model is used.

The server contributes to an improvement in computer technology by introducing specific processing mechanisms and data structures that are not merely a computerization of human translation work. For example, the server defines a motion-energy measure over joint velocities that allows automatic and robust temporal segmentation of sign-language motion. The server defines body-part feature vectors and symbol sequences that map complex pose trajectories into compressed codes, enabling hardware-accelerated sequence processing and reducing memory bandwidth requirements. The server uses prompt-sentence design as a controllable interface between symbolic codes and generative models, resulting in predictable behavior and reduced need for manual post-editing.

The server also implements non-conventional training procedures that exploit user evaluation information. For example, the server may define an auxiliary loss term that penalizes symbol sequences associated with frequent user rejections and reward sequences associated with user confirmations. The server may adjust model hyperparameters, such as learning rates or regularization coefficients, based on aggregate user feedback. This closed-loop adaptation enables the server to handle diverse signing styles and contexts, improving recognition performance on non-stationary input distributions.

In another embodiment, the server executes the generative AI model locally rather than using an external service. The server stores a transformer-based language model comprising multiple encoder-decoder layers with attention mechanisms. The server loads the model parameters from a storage device into memory at startup. The server partitions the model across multiple processing units, for example by assigning certain layers to a graphics processing unit and others to the central processing unit, to optimize throughput. The server may quantize model weights to a reduced bit-width, such as 8 bits, to reduce memory usage and accelerate matrix multiplications. The server then generates natural-language text information by performing forward propagation through the network using the prompt sentence as input.

In yet another embodiment, the server uses different types of imaging apparatus and terminal configurations. The imaging apparatus may be a depth camera or a stereo camera, enabling the server to include depth information in the body-part feature vectors. The terminal may be a dedicated kiosk with a larger display device and more powerful audio output device. In such a configuration, the terminal can display additional contextual information, such as recognized sign-language tokens or visualization of joint trajectories, to assist human operators in verifying system behavior.

The terminal may also participate in preprocessing operations. For instance, the terminal may receive a compressed video stream from the imaging apparatus, decode the stream using a media codec, and perform basic operations such as frame cropping and downscaling before transmitting the processed frames to the server. By offloading part of the computation to the terminal, the system can reduce server load and network bandwidth usage, thus improving scalability when many users interact with the system simultaneously.

The user interacts with the system in real-world environments. The user does not need to understand the internal processing, but can experience reduced waiting times and more natural spoken output as the system improves through continuous learning. The system's technical features—temporal segmentation, feature extraction, symbol-sequence generation, structured prompt sentences, multi-stage generative processing, and feedback-based adaptation—collectively produce a concrete improvement in computer-based sign-language translation, resulting in enhanced accuracy, reduced latency, and more reliable and polite speech output in real time.

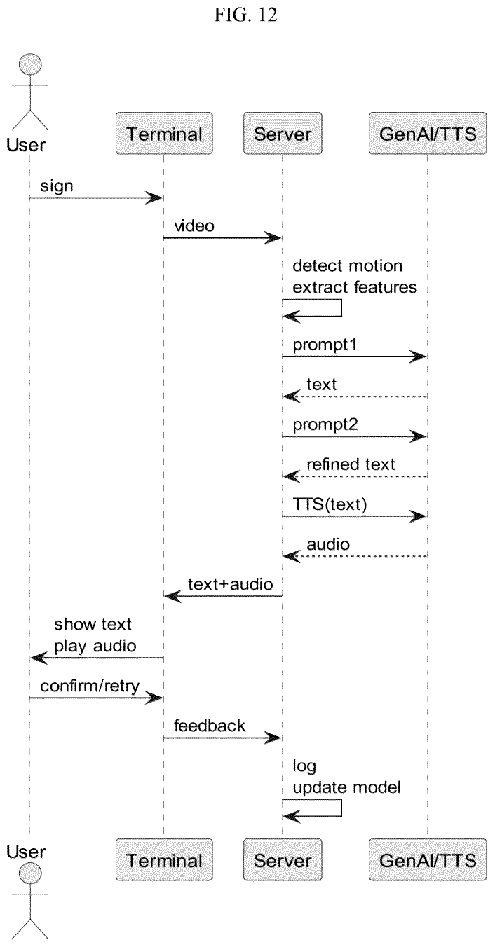

The following describes the processing flow using FIG. 12.

Step 1:

The server acquires raw image information from an imaging apparatus.

The server receives as input a continuous stream of image frames representing a user's upper body and hands, typically in a compressed video format. The server decodes the video stream into individual frames using a media codec, converts each frame to a standard color space, and stores the frames in a frame buffer in main memory. The server thereby outputs a sequence of decoded frames with time stamps, which are ready for further analysis.

Step 2:

The server performs preprocessing and region extraction on the image information.

The server takes as input the decoded frame sequence from Step 1. The server resizes each frame to a fixed resolution, normalizes pixel values, and applies noise reduction filters. The server executes a pose-estimation network to detect keypoints for body parts such as hands, wrists, elbows, and shoulders. Based on these keypoints, the server computes a bounding region that includes the sign-language motion and crops the frame accordingly. The server outputs cropped frame sequences and associated keypoint data structures that localize the sign-language region.

Step 3:

### The Server Segments the Image Information Into Temporal Sections Representing Sign-language motion.

The server receives as input the sequence of keypoints and cropped frames from Step 2. The server calculates motion features such as velocities of hand keypoints and overall motion energy per frame by summing squared velocity components. The server compares the motion energy against predefined thresholds to detect the start and end of meaningful sign-language motion. The server groups consecutive frames between detected start and end points into temporal sections. The server outputs a set of temporal sections, each identified by start and end time stamps and associated with the corresponding cropped frames and keypoint sequences.

Step 4:

The server extracts body-part feature information from each temporal section.

The server takes as input the temporal sections from Step 3. For each temporal section, the server computes feature vectors that encode relative joint positions, normalized bone lengths, joint angles, and temporal derivatives such as velocities and accelerations. The server stacks these feature vectors in time order to form a feature sequence tensor for each temporal section. The server outputs, for each temporal section, a structured feature sequence representing the dynamics of sign-language motion in a compact numerical form.

Step 5:

The server generates a symbol sequence corresponding to a sign-language expression.

The server receives as input the feature sequence tensors from Step 4. The server feeds each feature sequence into a sequence model, such as a recurrent neural network or transformer-based encoder, configured with learned weights. The server performs forward propagation layer by layer, applying matrix multiplications, nonlinear activations, and attention mechanisms to capture temporal dependencies. The server decodes the model outputs into discrete tokens by selecting, at each time step or for the entire sequence, the most probable symbol from a predefined vocabulary. The server may apply a decoding algorithm such as beam search or connectionist temporal classification decoding to obtain a stable symbol sequence. The server outputs, for each temporal section, a symbol sequence such as “PRODUCT/INFORMATION/REQUEST” along with auxiliary information including confidence scores and timing markers.

Step 6:

The server constructs a first prompt sentence for a generative AI model based on the symbol sequence.

The server takes as input the symbol sequence and auxiliary information from Step 5. The server loads a prompt template from a configuration store, for example, a text pattern including placeholders for tokens and context. The server replaces placeholders with the actual symbol sequence and contextual cues such as “customer” or “shop” based on system settings. The server concatenates these elements into a human-readable prompt sentence. For example, the server generates a prompt sentence such as:

“The following is a sequence of sign-language tokens representing a customer's request in a shop. Convert these tokens into one polite, natural sentence in English that could be spoken aloud: PRODUCT/INFORMATION/REQUEST.”

The server outputs this first prompt sentence as a text string ready to be sent to the generative AI model.

Step 7:

The server obtains natural-language text information from the generative AI model using the first prompt sentence.

The server receives as input the first prompt sentence from Step 6. The server transmits the prompt sentence to a generative AI model endpoint over a network, or forwards it to a locally hosted generative AI model. The generative AI model internally processes the prompt using its neural network layers, but from the server's perspective, the server sends a text input and receives a text output. The server parses the response payload to extract the generated text, for example, “Please tell me about this product.” The server associates this generated text with the original temporal section and symbol sequence, and outputs the natural-language text information as an intermediate translation result.

Step 8:

The server constructs a second prompt sentence for notation unification and style conversion.

The server takes as input the natural-language text information from Step 7. The server loads a second template designed for text refinement. The server embeds the generated text into the template, for example:

“Rewrite the following sentence so that it is polite and natural when spoken by a customer to a store clerk in English. Keep the meaning the same and output only the corrected sentence: ‘Please tell me about this product.’”

The server concatenates the fixed instruction part and the embedded sentence, forming the second prompt sentence. The server outputs this second prompt sentence for further processing by the generative AI model.

Step 9:

The server generates formatted text information suitable for speech from the second prompt sentence.

The server receives as input the second prompt sentence from Step 8. The server sends the second prompt sentence to the generative AI model in the same manner as in Step 7. The generative AI model returns a refined sentence. The server extracts the text, for example, “Could you please tell me about this product?”, and discards any auxiliary commentary if present. The server then optionally performs additional local normalization, such as ensuring proper punctuation and expanding abbreviations. The server outputs the final formatted text information, which is ready for text-to-speech conversion and display.

Step 10:

The server converts the formatted text information into acoustic information.

The server takes as input the formatted text information from Step 9. The server prepares a request for a speech-generation processing unit, specifying the text, language code, voice type, and audio format. The server transmits this request to a text-to-speech module or external service and waits for an audio response. The server receives an audio stream or file as acoustic information, decodes or re-encodes it if necessary, and may normalize volume levels or trim leading/trailing silence. The server outputs the processed acoustic information in a format suitable for streaming to the terminal.

Step 11:

The terminal receives and plays back the acoustic information.

The terminal receives as input the acoustic information streamed from the server. The terminal buffers incoming audio packets, decodes them using an operating system audio API, and writes audio samples to an audio output device such as a loudspeaker. The terminal may adjust playback volume based on device settings or ambient noise measurements. The terminal outputs audible speech corresponding to the user's sign-language input, enabling a hearing person nearby to understand the content.

Step 12:

The terminal displays the formatted text information for confirmation by the user.

The terminal receives as input the formatted text information from the server. The terminal renders the text in a user interface component on the display, for example, showing “Could you please tell me about this product?” along with confirmation and retry buttons. The terminal may also highlight the text or show a preview icon indicating that the text is linked to the currently played audio. The terminal outputs a visual representation that allows the user to verify whether the translated text matches the intended meaning.

Step 13:

The user confirms or rejects the formatted text information.

The user takes as input the displayed formatted text information on the terminal's screen. The user reads the text and decides whether it accurately reflects the sign-language expression. The user taps a confirmation button if the text is correct, or taps a retry button if the text is incorrect or incomplete. The user's action produces an input event which the terminal captures and forwards as a control signal to the server. The user thus outputs a binary decision (approve or reject) that guides subsequent processing.

Step 14:

The server controls conversion or re-input based on the user's confirmation.

The server receives as input the control signal from the terminal indicating user confirmation or rejection. If the signal indicates confirmation, the server maintains the current acoustic information and may mark the translation as successful in its logs. If the signal indicates rejection, the server discards or flags the corresponding translation and may request the terminal to prompt the user to repeat the sign-language motion. The server updates an internal state machine per session to track whether a given temporal section has been successfully translated. The server outputs updated session status and, if necessary, new instructions to the terminal.

Step 15:

The server logs multimodal information for learning and improvement.

The server takes as input image information, symbol sequences, auxiliary information, natural-language text information, formatted text information, acoustic information, and user evaluation outcomes (confirmation or rejection) associated with each interaction. The server structures these data into log records with identifiers and time stamps and writes the records into a storage subsystem such as a database. The server may compress or index parts of the data for efficient retrieval. The server outputs persistent log information that accumulates over many interactions and forms a basis for learning data.

Step 16:

The server generates learning data and updates models and prompt sentences.

The server receives as input the accumulated log information from Step 15. The server extracts training pairs, such as feature sequences and corrected symbol sequences, or rough text and user-approved formatted text. The server computes error signals by comparing model outputs with user-approved targets and uses these errors to perform parameter updates on the recognition model via gradient-based optimization. The server also analyzes which prompt sentence patterns correlate with higher approval rates, and modifies or re-ranks prompt templates accordingly. The server outputs updated model parameters and revised prompt templates, which are then used in subsequent executions of Steps 5 through 9 to improve recognition accuracy, text quality, and processing efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional sign language interpretation systems that convert sign language into spoken language often rely on monolithic, rule-based pipelines or fixed classification models. These systems typically perform direct mapping from video frames to text without extracting structured motion features or leveraging advanced generative models. As a result, they suffer from limited recognition accuracy, poor adaptability to variations in user motion, and difficulty in handling contextual nuances in natural language output. Furthermore, such systems are frequently implemented as tightly coupled, on-device solutions that do not flexibly distribute processing between terminals and remote computing resources, leading to inefficient use of computation and network bandwidth, increased latency, and scalability limitations.

In particular, existing techniques do not sufficiently exploit an intermediate representation between raw image data and natural-language text, such as sequences of feature points of body parts and associated motion tokens, which could be processed more efficiently and robustly by machine learning models. Additionally, known systems generally do not employ prompt-based control of generative AI models to adaptively generate natural-language text reflecting dialog context, thereby limiting the naturalness and informativeness of the output. Moreover, conventional text-to-speech components in sign language conversion systems usually apply static prosody settings that are not dynamically adjusted based on estimated emotional states derived from user expressions or voice cues. This results in synthesized speech that is monotonous and less aligned with the communicative intent of the signer. Taken together, these constraints lead to suboptimal computer performance in terms of processing efficiency, accuracy, latency, scalability, and quality of user interaction.

Accordingly, there is a need for an improved computer-implemented system that: (i) processes time-series image data of sign language by extracting feature point sequences and generating intermediate representation sequences; (ii) utilizes prompt-driven generative AI models to produce context-aware natural-language character information; (iii) dynamically allocates processing tasks between local and external computing resources; and (iv) adjusts speech synthesis parameters based on estimated emotional states, thereby enhancing overall system-level performance and interaction quality.

The specific processing by the specific processing unit 290 of the data processing device 12 in Example 2 is realized by the following means.

The present invention provides a server comprising a processor configured to acquire motion information including movements of fingers and a body by using an imaging device, generate time-series image data based on the acquired motion information, extract sequences of feature points of body parts from the time-series image data, recognize, based on the sequences of feature points, an intermediate representation sequence indicating predetermined motion expressions, generate a prompt sentence that instructs a generative AI model to generate natural-language character information using the intermediate representation sequence as input information, obtain the character information from the generative AI model based on the prompt sentence, generate context information of a dialogue based on at least one of the intermediate representation sequence and the character information and include the context information in the prompt sentence to control generation content of the character information by the generative AI model, execute speech synthesis processing to convert the character information into an acoustic signal while changing a speaker characteristic parameter according to an estimated emotional state obtained by analyzing at least one of expression information and voice information included in the time-series image data, output the acoustic signal via an acoustic output device, and transmit and receive at least one of the time-series image data, the intermediate representation sequence, and the character information through a communication path to and from an external device so as to distribute and execute at least one of acoustic-signal generation processing and image-data analysis processing to the external device. This enables improved computer functionality by transforming raw multimedia input into a structured intermediate representation that reduces computational complexity, leveraging prompt-controlled generative AI models to generate context-aware and semantically rich text, dynamically offloading processing between local and remote resources to optimize latency and scalability, and adaptively controlling speech synthesis parameters based on estimated emotional states, thereby enhancing recognition accuracy, processing efficiency, and the naturalness of system output in sign language communication scenarios.

The term “system” refers to an arrangement including at least one computing apparatus and one or more peripheral apparatuses that cooperate to execute the processing described in the claims.

The term “processor” refers to any hardware logic element or combination of elements configured to execute instructions, including but not limited to a central processing unit, a graphics processing unit, a digital signal processor, a programmable logic device, or a combination thereof.

The term “imaging device” refers to any apparatus capable of optically or electronically capturing motion of an object and outputting corresponding image data, including but not limited to a camera, an image sensor module, or a depth sensor.

The term “motion information” refers to data representing temporal changes in positions or postures of at least part of a subject, including but not limited to movements of fingers, hands, arms, or a body.

The term “time-series image data” refers to a plurality of image frames arranged in temporal order and representing motion of a subject over time.

The term “image data” refers to digital information representing at least one image frame, including but not limited to pixel values, color components, or depth values.

The term “feature points of body parts” refers to representative points on anatomical regions of a subject, including but not limited to joints, fingertips, and limb endpoints, which are used to describe the pose or motion of the subject.

The term “sequences of feature points” refers to ordered sets of feature points or coordinates over time that collectively describe temporal changes in pose or motion.

The term “intermediate representation sequence” refers to a sequence of symbolic or numerical elements that abstracts motion patterns of a subject from raw image data and indicates predetermined motion expressions such as units of sign language.

The term “predetermined motion expressions” refers to defined categories or units of motion, including but not limited to gestures, signs, or pose patterns, that are used to represent semantic content.

The term “prompt sentence” refers to a textual instruction or query provided to a generative AI model, the content of which is configured to cause the generative AI model to generate desired output information based on given input data.

The term “generative AI model” refers to a machine-learned model configured to generate output data such as character information or natural-language sentences in response to input data and a prompt sentence, including but not limited to a large language model or a sequence-to-sequence model.

The term “character information” refers to digital text data representing linguistic content in a written form, including but not limited to sequences of characters, symbols, or tokens.

The term “context information of a dialogue” refers to information representing at least part of a conversational state, including but not limited to preceding utterances, topics, or user intent, which is used to condition generation of character information.

The term “speech synthesis processing” refers to processing that converts character information into an acoustic signal representing speech, including but not limited to text normalizing, phoneme conversion, prosody generation, and waveform synthesis.

The term “acoustic signal” refers to a digital or analog representation of sound, including but not limited to a waveform or encoded audio data that can be reproduced as audible sound.

The term “acoustic output device” refers to any apparatus configured to convert an acoustic signal into audible sound, including but not limited to a loudspeaker, a headphone, or an earphone.

The term “communication path” refers to any physical or logical medium for transmitting data between devices, including but not limited to wired networks, wireless networks, and communication protocols implemented thereon.

The term “external device” refers to a computing apparatus or peripheral apparatus that is separate from the primary processor but is capable of communicating with the primary processor via a communication path.

The term “acoustic-signal generation processing” refers to at least part of processing that produces an acoustic signal from non-acoustic data, including but not limited to text-to-speech conversion or audio encoding.

The term “image-data analysis processing” refers to processing that derives higher-level information from image data, including but not limited to feature extraction, pose estimation, gesture recognition, or classification.

The term “dialogue” refers to a sequence of exchanges of information between at least two parties, including but not limited to interactions between users or between a user and a system.

The term “expression information” refers to information representing facial or bodily expressions of a subject, including but not limited to changes in facial landmarks, muscle movement, or body posture.

The term “voice information” refers to information relating to an acoustic signal produced by a subject, including but not limited to pitch, energy, spectral characteristics, or temporal patterns of speech.

The term “emotional state” refers to an inferred affective condition of a subject, including but not limited to happiness, sadness, anger, surprise, or neutrality, estimated from expression information or voice information.

The term “speaker characteristic parameter” refers to a control parameter used in speech synthesis processing to influence perceived attributes of synthesized speech, including but not limited to pitch, speaking rate, timbre, or intonation.

In one embodiment, a server cooperates with at least one terminal and at least one user to implement a sign-language-to-speech conversion system. The server includes a processor, a memory storing program instructions and trained model parameters, a network interface, and optionally one or more hardware accelerators such as a graphics processing unit. The terminal includes a processor, a memory, an imaging device such as a digital camera, an acoustic output device such as a loudspeaker, and a communication interface such as a wireless transceiver. The user performs sign language and other gestures in front of the imaging device, and the system converts such gestures into natural-language character information and synthesized speech.

The terminal uses the imaging device to capture motion information including movements of fingers and a body of the user. The terminal converts optical signals sensed by the imaging device into time-series image data that consists of a sequence of image frames. The terminal temporarily stores the image frames in a frame buffer in the memory. The terminal optionally compresses the time-series image data using a video encoding algorithm such as a block-based motion compensation scheme and transmits the compressed image data to the server via the communication interface and the network interface.

The server receives the time-series image data and reconstructs individual image frames in a decoding module. The server uses an image-processing library, such as a general-purpose image-processing library, to perform pixel-level operations including resizing, normalization, and noise reduction on each image frame. The server converts pixel values into normalized floating-point values suitable for input to neural network models. The server then applies a pose-estimation and hand-tracking module that extracts sequences of feature points of body parts from the image data.

The server, in one implementation, uses a convolutional neural network combined with a keypoint detection architecture to infer two-dimensional coordinates of anatomical landmarks such as wrists, knuckles, and fingertips in each image frame. The server represents each keypoint as a tuple including at least an x-coordinate, a y-coordinate, and a confidence value. The server stores such tuples as elements of a fixed-length vector for each frame. The server constructs a time-series tensor by stacking these vectors over multiple frames, thereby representing the temporal evolution of body-part positions as sequences of feature points.

The server uses a sequence recognition module to convert the sequences of feature points into an intermediate representation sequence. In one embodiment, the server applies a recurrent neural network architecture such as a long short-term memory network or a gated recurrent unit network to model temporal dependencies between feature-point vectors. The server, in another embodiment, uses a transformer-based sequence model employing multi-head self-attention layers. The server feeds the time-series tensor to this sequence recognition module, which outputs probability distributions over a vocabulary of motion tokens representing predetermined motion expressions such as sign-language units or glosses.

The server computes a loss function such as a cross-entropy loss or a connectionist temporal classification loss during training and updates model parameters using a gradient-based optimization algorithm such as stochastic gradient descent or an adaptive moment method. The server trains the sequence recognition module on a dataset of labeled sequences of feature points and corresponding motion tokens, possibly with data augmentation techniques such as temporal jittering, random scaling of coordinates, and synthetic noise injection to improve robustness. These training operations, although mainly performed offline, define the internal structure of the trained model that operates at run-time in the system.

The server decodes the probability distributions over motion tokens using a decoding method such as beam search to produce an intermediate representation sequence. The intermediate representation sequence is a list of symbolic tokens indicating recognized motion expressions. The server may apply additional constraints such as a language model over motion tokens to reduce recognition errors. Because the server operates on feature-point sequences instead of raw pixel data, the server reduces the dimensionality of the input and focuses computation on motion-relevant information. This improves computational efficiency, reduces memory usage, and enhances recognition robustness against background variation and lighting changes.

The server uses the intermediate representation sequence to generate a prompt sentence for a generative AI model. The server constructs the prompt sentence as a textual instruction that includes at least the intermediate representation sequence and, optionally, context information of a dialogue. For example, the server constructs a prompt sentence such as:

“You are a translation engine that converts sign language gloss sequences into natural sentences in Japanese. Gloss sequence: ‘KONNICHIWA’. Output only the final natural Japanese sentence.”

In another example, the server uses a prompt sentence that additionally includes prior dialogue turns, such as:

“Previous utterance: ‘How are you today?’. Current sign gloss sequence: ‘KONNICHIWA’. Generate a natural response in Japanese that fits the conversation.”

The server combines the intermediate representation sequence and the context information into a structured text string according to a predefined prompt format. The server thus applies a non-conventional data structure for the input of the generative AI model, where a sequence of motion tokens and explicit context markers are embedded into the prompt sentence. This design allows the generative AI model to interpret sign-language-specific tokens within a controlled instruction environment, thereby improving translation accuracy and contextual consistency.

The server sends the prompt sentence as input to the generative AI model. The server, in one embodiment, executes the generative AI model locally on the processor and the memory. In another embodiment, the server invokes an external generative AI service via the network interface. The generative AI model uses a neural network architecture such as a transformer with multiple attention layers. The model receives the prompt sentence as a sequence of token embeddings, applies self-attention mechanisms to compute relationships between tokens, and generates character information token by token according to trained parameters. The model parameters are obtained through a pretraining process on a large corpus of text and an optional fine-tuning process using sign-language-related text pairs. The server controls generation behavior through parameters such as a temperature value, a maximum token count, and a top-probability threshold, and through the structure of the prompt sentence itself. The server receives generated character information from the generative AI model as a sequence of text tokens. The server concatenates these tokens into a character string, removes any auxiliary explanations that may be included, and normalizes the text encoding. The server may perform post-processing such as punctuation normalization and language-specific corrections. The server stores the resulting character information as the recognized content of the user's sign-language input.

The server uses the intermediate representation sequence and the character information to maintain context information of a dialogue. The server stores dialogue turns in a session memory. Each dialogue turn includes fields for intermediate representation sequences, character information, timestamps, and optional user identifiers. The server uses these stored fields to construct subsequent prompt sentences that embed both the current intermediate representation sequence and summarized context from previous turns. By explicitly encoding context in this manner, the server controls the generative AI model to produce context-aware character information without relying solely on implicit state inside the model. This improves coherence of multi-turn interactions and reduces ambiguous translations.

The server performs speech synthesis processing to convert the character information into an acoustic signal. The server uses a text-to-speech engine. The server supplies the character information to the text-to-speech engine, which executes text normalization, phoneme conversion, prosody prediction, and waveform synthesis. In one implementation, the text-to-speech engine uses a sequence-to-sequence architecture that maps phoneme sequences to mel-spectrograms, followed by a neural vocoder that converts mel-spectrograms to audio waveforms. The server selects a speaker profile and voice characteristics for the synthesis. The server further analyzes expression information or voice information to estimate an emotional state. The server obtains expression information by detecting facial landmarks and computing feature vectors that describe facial muscle configurations. The server, in another embodiment, obtains voice information by analyzing pitch contours, intensity, and spectral features of an input voice signal. The server uses a classifier model, such as a neural network with fully connected layers or a support vector machine, to map these feature vectors to an emotional-state label. The server then adjusts speaker characteristic parameters, such as pitch, speaking rate, and prosodic emphasis, in the text-to-speech engine according to the estimated emotional state. For example, the server increases pitch and speed for an excited state and decreases them for a sad state. This adjustment leads to synthesized speech that better matches the communicative intent.

The server outputs the acoustic signal to the terminal via the communication interface. The terminal receives the acoustic signal, decodes it if encoded in a compressed audio format, and forwards the decoded audio samples to the acoustic output device. The acoustic output device converts the audio samples into audible sound, allowing the user to hear the spoken version of the sign-language input. The terminal may additionally display the character information on a screen, enabling a user to view textual content simultaneously with audio playback.

The server distributes computation between itself and the terminal or another external device to improve processing efficiency. In an example embodiment, the terminal executes pre-processing stages such as frame capture and basic compression, while the server performs computationally intensive tasks such as feature-point extraction, sequence recognition, and generative AI processing. In another embodiment, a separate external device performs the text-to-speech synthesis, with the server focusing on recognition and prompt construction. The server decides which tasks to offload based on network latency measurements, available processing resources, or dynamic load-balancing policies. This distributed processing scheme reduces end-to-end latency, optimizes resource usage, and scales to multiple concurrent users. The server thereby improves computer technology by introducing a multi-stage data structure that transforms raw image data into sequences of feature points and intermediate representation sequences before invoking a generative AI model. This transformation reduces data size, concentrates information relevant to sign-language semantics, and allows the generative AI model to operate on structured symbolic inputs rather than unstructured pixels. As a result, the server achieves higher recognition accuracy and reduced computational cost compared to a straightforward direct mapping from video frames to text. Furthermore, the explicit use of prompt sentences embedding both motion tokens and dialogue context provides a non-conventional interface to the generative AI model that minimizes hallucinated outputs and improves robustness.

The server also improves computer performance by performing specialized optimization in model training and inference. During training, the server uses a mini-batch processing strategy, an adaptive learning-rate schedule, and regularization techniques such as dropout to stabilize convergence. The server uses early stopping criteria based on validation performance to avoid overfitting. During inference, the server prunes low-confidence feature points, limits beam-search width based on confidence thresholds, and caches intermediate computations for repeated motion patterns. These practices lead to faster processing times and lower memory usage, which are technical improvements over naive implementations that process entire images and full probability distributions without such optimizations.

The server, in some variations, employs alternative neural-network architectures, such as graph-based neural networks that treat feature points as nodes in a graph, or convolutional temporal networks that operate on time-series of coordinates. The server can also use alternative loss functions, such as margin-based losses for structured prediction, to further enhance recognition performance. The system thereby supports multiple implementation modes while maintaining the core structure of converting feature-point sequences into intermediate representation sequences and then into natural-language character information. The terminal, in some embodiments, may execute part of the feature-point extraction locally by using a lightweight neural network optimized for mobile processors. The terminal then sends only the feature-point sequences to the server, instead of full image frames. This reduces required network bandwidth and improves privacy, as raw images are not transmitted. The server subsequently applies the sequence recognition module and the generative AI model based on the reduced data. This configuration yields technical effects including communication-load reduction and improved system responsiveness in constrained network environments.

The user interacts with the system by performing sign language in front of the imaging device and listening to or viewing the converted output. The user may also adjust system parameters through a graphical interface on the terminal, such as selecting a preferred language, setting voice characteristics, or enabling or disabling emotional-state-aware synthesis. These user interactions do not alter the fundamental technical processes but demonstrate practical use cases in which the system provides real-time sign-language communication support with improved computational efficiency, accuracy, and naturalness of the output.

Through the above configuration, the server, the terminal, and the user collectively achieve a technical solution that goes beyond simple automation of human interpretation. The system integrates specialized data representations, neural-network architectures, generative AI models controlled by structured prompt sentences, and adaptive speech synthesis to improve recognition accuracy, processing speed, communication efficiency, and audio quality. The described embodiments, variations, and alternatives collectively illustrate how the claimed invention can be implemented in practice and how the combination of hardware and software yields concrete technical effects in real-world environments.

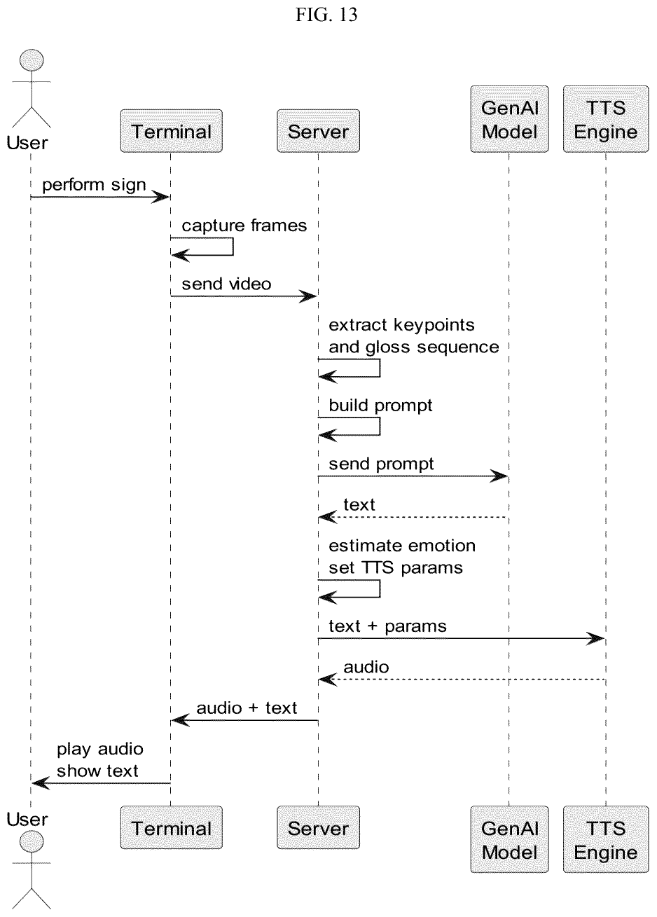

The following describes the processing flow using FIG. 13.

Step 1:

User positions body and performs sign language.

User places the upper body and both hands within the field of view of the imaging device of the terminal. User performs a sign-language expression, such as a greeting, by moving fingers, hands, and arms according to sign-language rules.

Input: Human body motion in physical space.

Output: Optical patterns incident on the imaging device.

Step 2:

Terminal captures optical signals and generates raw image frames.

Terminal uses the imaging device to convert the incoming optical patterns into electrical signals, and then converts the electrical signals into digital image frames using an image sensor and a device driver. Terminal assigns timestamps to each frame and stores them in a frame buffer in memory as raw image data (for example, RGB or YUV arrays).

Input: Optical patterns from the user's motion.

Output: Time-ordered raw image frames stored as pixel arrays.

Step 3:

Terminal performs local pre-processing and optional compression.

Terminal applies basic image pre-processing, such as resizing to a target resolution, color-space conversion, and noise reduction using an image-processing library. Terminal may crop the region of interest around the user's upper body and hands using a lightweight on-device detection model. Terminal optionally encodes the sequence of pre-processed frames into a compressed video bitstream using a block-based video codec.

Input: Raw image frames from Step 2.

Output: Pre-processed and optionally compressed time-series image data suitable for transmission.

Step 4:

Terminal transmits time-series image data to the server.

Terminal constructs a transmission payload that includes the time-series image data and metadata such as session identifiers, timestamps, and language settings. Terminal segments the payload into network packets, applies a transport protocol, and sends the packets through a communication interface such as a wireless module.

Input: Pre-processed time-series image data and metadata from Step 3.

Output: Network packets containing time-series image data and metadata sent to the server.

Step 5:

Server receives and reconstructs the time-series image data.

Server receives the network packets via a network interface, validates packet integrity, and reassembles the packets into the original payload. Server decodes the compressed stream if necessary and reconstructs the time-series image data as a sequence of image frames in main memory.

Input: Network packets transmitted from the terminal in Step 4.

Output: Reconstructed time-series image data stored as ordered image frames on the server.

Step 6:

Server performs frame-level image normalization.

Server uses an image-processing module to standardize each frame by resizing to a fixed input size, normalizing pixel intensity values, and optionally applying background suppression. Server converts pixel arrays into normalized tensors with a fixed shape, suitable for input to subsequent neural-network models.

Input: Time-series image frames from Step 5.

Output: Normalized frame tensors representing each image frame.

Step 7:

Server extracts feature points of body parts in each frame.

Server applies a pose-estimation and hand-tracking model to each normalized frame tensor. Server computes for each frame the coordinates and confidence scores of anatomical keypoints such as wrist, knuckles, and fingertips. Server packs these keypoints into a fixed-length feature vector for each frame, where each element encodes at least a coordinate pair and a confidence value.

Input: Normalized frame tensors from Step 6.

Output: Per-frame feature vectors containing feature points of body parts.

Step 8:

Server constructs a time-series of feature-point vectors.

Server arranges the per-frame feature vectors in chronological order to form a time-series tensor. Server may interpolate missing keypoints, smooth noisy coordinates, and normalize coordinates relative to a reference (for example, torso position) to reduce variation. This produces a structured multi-dimensional array representing motion over time.

Input: Per-frame feature vectors from Step 7.

Output: Time-series tensor of feature-point vectors representing the user's motion.

Step 9:

Server recognizes an intermediate representation sequence.

Server inputs the time-series tensor into a sequence recognition module, such as a recurrent neural network or a transformer-based model. Server performs matrix multiplications, non-linear activations, and attention operations layer by layer to compute, at each time step, probability distributions over a predefined vocabulary of motion tokens. Server decodes these probability distributions using a decoding algorithm (for example, beam search or sequence alignment) to generate an intermediate representation sequence that indicates recognized motion expressions.

Input: Time-series tensor of feature-point vectors from Step 8.

Output: Intermediate representation sequence as a sequence of motion tokens.

Step 10:

Server generates dialogue context information.

Server accesses a session store that contains previous intermediate representation sequences and previously generated character information for the same user session. Server aggregates these past entries, applies a summarization or selection rule, and creates dialogue context information that represents the relevant conversational history.

Input: Current intermediate representation sequence from Step 9 and stored session data.

Output: Dialogue context information describing prior and current interaction state.

Step 11:

Server constructs a prompt sentence for the generative AI model.

Server combines the intermediate representation sequence and the dialogue context information into a structured textual instruction. Server formats the instruction according to a pre-defined template to create a prompt sentence that guides the generative AI model. For example, the server may generate:

“You are a translation engine that converts sign language gloss sequences into natural sentences in Japanese. Previous utterances: ‘How are you today?’. Current gloss sequence: ‘KONNICHIWA’. Output only the final natural Japanese sentence.”

Server encodes the intermediate representation sequence and context information as specific segments inside the prompt sentence to clearly separate instructions and data.

Input: Intermediate representation sequence from Step 9 and dialogue context information from Step 10.

Output: Prompt sentence as a text string for input to the generative AI model.

Step 12:

Server invokes the generative AI model and obtains character information.

Server sends the prompt sentence to the generative AI model, either locally or through a networked service. Server converts the text into token IDs, and the generative AI model performs embedding lookup, attention-based transformations, and sequential decoding according to its trained parameters. Server receives the generated tokens from the model and concatenates them into a text string. Server then removes extra explanations or formatting and normalizes the text.

Input: Prompt sentence from Step 11.

Output: Character information as a natural-language text string corresponding to the recognized sign language.

Step 13:

Server updates dialogue history and session state.

Server stores the new intermediate representation sequence and the generated character information in the session store along with timestamps and other metadata. Server may also update a summarized context field for efficient retrieval in later interactions. This updates the internal data structures that support subsequent context-aware prompt generation.

Input: Intermediate representation sequence from Step 9 and character information from Step 12.

Output: updated session data containing extended dialogue history.

Step 14:

Server estimates an emotional state from expression or voice information.

Server analyzes expression information in the image data by applying a facial-landmark detection model and computing feature vectors that represent facial muscle configuration. Alternatively, server analyzes voice information, if available, by computing acoustic features such as pitch, energy, and spectral coefficients. Server inputs these feature vectors into an emotion-classification model that outputs an emotional-state label or a probability distribution over emotional categories.

Input: Expression information derived from image frames and/or voice information associated with the user.

Output: Estimated emotional state or probability distribution over emotional states.

Step 15:

Server configures speech synthesis parameters according to emotional state.

Server maps the estimated emotional state to synthesis control values such as pitch shift, speaking rate multiplier, and prosodic emphasis patterns. Server updates a set of speaker characteristic parameters for the text-to-speech engine, including voice timbre selection and intonation templates, based on the mapping.

Input: Estimated emotional state from Step 14 and a mapping rule between emotional states and synthesis parameters.

Output: Speaker characteristic parameters configured for subsequent speech synthesis.

Step 16:

Server performs text-to-speech conversion.

Server provides the character information and the configured speaker characteristic parameters to the text-to-speech engine. The text-to-speech engine performs text normalization, converts text into phoneme sequences, predicts prosody curves according to the parameters, and synthesizes an audio waveform using a waveform generation model.

Server receives the generated audio waveform and, if necessary, encodes it into a compressed audio format suitable for transmission.

Input: Character information from Step 12 and speaker characteristic parameters from Step 15.

Output: Acoustic signal representing synthesized speech, optionally in a compressed format.

Step 17:

Server transmits synthesized audio and optional text to the terminal.

Server packages the acoustic signal and, optionally, the character information into a response message. Server adds metadata such as duration, language code, and encoding format. Server then sends the response message to the terminal through the network interface using a communication protocol.

Input: Acoustic signal and character information from Step 16.

Output: Network packets containing the acoustic signal and optional character information transmitted to the terminal.

Step 18:

Terminal receives and outputs audio (and optionally displays text).

Terminal receives the response message, reassembles the acoustic signal, and decodes it if compressed. Terminal forwards the decoded audio samples to the acoustic output device, which converts the samples to audible sound for the user. Terminal may also render the character information on a display as subtitles or text output synchronized with the audio.

Input: Response message containing the acoustic signal and optional character information from Step 17.

Output: Audible speech output to the user and optionally displayed text on the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional sign-language translation systems suffer from multiple technical limitations in how computers acquire, interpret, and present multimodal human communication. In many existing approaches, a processor simply maps isolated visual patterns of hand shapes to predefined text entries using static pattern-matching or simple classification. Such approaches typically ignore continuous time-series motion of body parts, facial expressions, and voice prosody, and therefore cannot robustly handle natural, continuous gesture expressions occurring in unconstrained environments. As a result, recognition accuracy degrades when gestures are fast, partially occluded, or context dependent, and the system often produces incomplete or unnatural text output.

Furthermore, conventional systems generally generate output text through fixed templates or rule-based substitution. These text outputs do not fully utilize advances in generative artificial intelligence and are not optimized for natural spoken interaction. The generated text tends to be rigid and does not adapt to conversational style, politeness level, or domain-specific phrasing. This causes a mismatch between the nuanced, context-rich input signals and the simplistic, inflexible textual representation, and thus reduces the effectiveness of computer-mediated communication.

In addition, many systems treat speech synthesis as a separate, downstream process that merely converts text to audio signals without integrated consideration of user emotion. Even when emotion recognition is performed, it is often decoupled from the text generation pipeline, so that emotional information is not consistently propagated from visual and audio cues into both the lexical content and prosodic parameters of synthesized speech.

Consequently, computers fail to generate emotion-aware spoken output that faithfully reflects both the semantic content and the emotional nuance intended by the user.

From the standpoint of computer technology, there is a need for an improved computational architecture that: (i) acquires visual information of gesture expressions and processes it as rich time-series feature data; (ii) uses machine learning models to convert such time-series data into base text with high accuracy; (iii) leverages a generative AI model via prompt sentences to refine and contextualize the base text; and (iv) integrates emotion information into both text generation and speech synthesis. Without such an integrated architecture, the processor cannot efficiently utilize multimodal inputs, generative models, and speech synthesis engines in a coordinated manner, and therefore cannot provide a technically improved pipeline for real-time, natural, and emotion-aware human-computer communication.

Accordingly, an object of the present invention is to provide a computer-implemented system and processing method that improve the way in which a processor (1) analyzes continuous visual information to recognize gesture expressions, (2) generates and refines text using a generative AI model controlled by prompt sentences, and (3) produces audio output whose lexical content and acoustic characteristics are dynamically controlled based on recognized emotion, thereby improving the technical quality, robustness, and expressiveness of multimodal communication processing in a computing environment.

The specific processing by the specific processing unit 290 of the data processing device 12 in Application Example 2 is realized by the following means.

The present invention provides a server comprising a processor configured to acquire visual information including a gesture expression by using an imaging device, analyze the acquired visual information to recognize content of the gesture expression, use feature information extracted from the visual information to input a time-series body motion into a machine learning model and generate base text including a character string corresponding to the gesture expression, generate a prompt sentence including the base text and a desired style of spoken language, input the prompt sentence into a generative information processing model to cause the generative information processing model to generate natural language text, input the natural language text into a speech synthesis technique to convert the natural language text into audio data, output the audio data through an acoustic output device, transmit the natural language text and the audio data to a terminal device, and cause the terminal device to display the natural language text and reproduce the audio data, and further configured, in some embodiments, to acquire a face image and an audio signal of a user, extract feature information indicating an emotional state to generate emotion information including an emotion type and an emotion intensity, add the emotion information to the prompt sentence to cause the generative information processing model to generate natural language text reflecting a nuance of the emotion, and control a fundamental frequency, a speaking rate, and a volume of the speech synthesis technique in accordance with the emotion information to generate audio data having an emotion tone. This enables the server to implement an integrated computational pipeline in which continuous visual and audio sensor data are transformed into rich time-series features, accurately recognized as gesture-based content, refined and contextualized through generative AI controlled by prompt sentences, and finally synthesized into emotion-aware speech, thereby improving recognition accuracy, naturalness of generated text, and expressiveness of synthesized audio in a computer-implemented multimodal communication system.

The term “system” refers to a combination of one or more hardware devices and software components that cooperate to execute the processing described in the claims, including at least a processor, an imaging device, and a terminal device.

The term “processor” refers to a hardware processing unit, such as a central processing unit, a graphics processing unit, a digital signal processor, or a combination thereof, that executes instructions to perform data acquisition, analysis, generation, and control operations according to the present invention.

The term “imaging device” refers to an apparatus configured to capture visual information of a scene as digital image data or video data, including, for example, a camera integrated in a portable terminal, a wearable device, or a fixed installation.

The term “visual information” refers to digital data representing one or more images or frames, or a sequence of such images or frames, obtained from the imaging device and including at least a depiction of a user's body, such as hands, arms, face, or upper body.

The term “gesture expression” refers to a visual expression formed by a user's body motion, including at least hand and arm movements and optionally facial expressions or body posture, which conveys semantic content such as words, phrases, or sentences.

The term “analyze” refers to performing computational processing on visual information or other data, including but not limited to filtering, segmentation, feature extraction, classification, and inference, in order to derive higher-level information such as recognized content.

The term “content of the gesture expression” refers to semantic information encoded in the gesture expression, including, for example, a linguistic meaning that can be represented as a character string, word sequence, or sentence.

The term “feature information” refers to numerical or symbolic data derived from raw sensor data, such as keypoint coordinates, motion vectors, region descriptors, or statistical measures, which characterize aspects of the gesture expression or user state.

The term “time-series body motion” refers to a sequence of body-related feature information, ordered in time, that describes the temporal evolution of a user's body parts, including their positions and movements across a plurality of frames.

The term “machine learning model” refers to a computational model whose parameters are trained using data, such as a neural network, a probabilistic model, or another data-driven model, that is configured to map input feature information to output predictions such as character strings.

The term “base text” refers to a first-stage textual representation, generated by the machine learning model from the time-series body motion, which includes at least a character string corresponding to the recognized gesture expression before any refinement by a generative model.

The term “character string” refers to a sequence of characters encoded in a machine-readable format, such as a string representing words, symbols, or sentences in a given natural language or notation.

The term “prompt sentence” refers to a textual input expression provided to a generative information processing model, which includes at least the base text and may further include style instructions or additional conditions, and which instructs the generative model to generate corresponding output text.

The term “generative information processing model” refers to a software-implemented model, such as a generative artificial intelligence model, that receives a prompt sentence and outputs generated natural language text by performing probabilistic or neural sequence generation.

The term “natural language text” refers to text composed in a human language, including words and sentences whose structure follows grammatical and semantic conventions of that language, suitable for being read or spoken by humans.

The term “speech synthesis technique” refers to a process or module that converts text input into corresponding audio data by generating an acoustic signal, and may include rule-based synthesis, concatenative synthesis, or neural speech synthesis.

The term “audio data” refers to digital data that represent sound signals, including sampled audio waveforms or encoded audio streams, which can be converted into audible sound by an acoustic output device.

The term “acoustic output device” refers to hardware configured to output sound, such as a loudspeaker, earphone, headphone, or any other transducer that converts audio data into audible acoustic waves.

The term “terminal device” refers to an end-user device, such as a portable information terminal, a wearable device, or a stationary display unit, that is configured to communicate with the server, display text, and reproduce audio data.

The term “display” refers to presenting visual information, such as natural language text or status information, on a display unit of the terminal device, including a screen or projection surface.

The term “reproduce the audio data” refers to causing the terminal device to convert received audio data into an analog signal and emit corresponding sound through an acoustic output component.

The term “user” refers to a person who performs gesture expressions and possibly produces facial expressions or voice, and whose communication is processed by the system.

The term “face image” refers to visual information that includes at least a region of a user's face, suitable for analysis of facial features or expressions.

The term “audio signal” refers to a time-varying signal representing sound, including voice produced by a user, captured by a microphone and converted into digital audio data.

The term “emotional state” refers to a condition of a user's affect, such as joy, sadness, anger, or neutrality, which can be inferred from facial expressions, voice characteristics, or other cues.

The term “emotion information” refers to data describing the emotional state of a user, including at least one emotion type and optionally an emotion intensity or confidence value.

The term “emotion type” refers to a category representing a kind of emotion, such as happiness, sadness, anger, surprise, fear, or a neutral state.

The term “emotion intensity” refers to a value indicating a degree or strength of the emotion type, which may be represented as a numeric score, probability, or level indicator.

The term “nuance of the emotion” refers to subtle qualitative aspects of the emotional state, including how strongly or in what manner the emotion should be reflected in generated text or speech.

The term “fundamental frequency” refers to a parameter of the speech signal corresponding to the perceived pitch of the voice, which can be adjusted to reflect different emotional tones.

The term “speaking rate” refers to a temporal parameter of synthesized speech, including the speed at which phonetic units or words are produced over time.

The term “volume” refers to an amplitude-related parameter of the audio signal, representing the perceived loudness of the synthesized speech.

The term “emotion tone” refers to a combination of prosodic characteristics in synthesized speech, including fundamental frequency, speaking rate, and volume, that together convey an intended emotional impression.

The term “time-series feature sequence” refers to an ordered set of feature vectors, each derived from a respective frame or time step, which collectively describe temporal changes in body parts or other observed elements.

The term “frame” refers to a single image unit within a sequence of visual information captured at a particular time point by the imaging device.

The term “position information of body parts” refers to data indicating spatial locations or coordinates of portions of a user's body, such as hands, arms, or facial landmarks, within a frame or three-dimensional space.

The term “motion information of body parts” refers to data derived from changes in position information over time, such as velocities, directions, or trajectories of the user's body parts.

The term “continuous gesture expression” refers to a non-discrete sequence of gesture movements occurring over time, which may comprise a plurality of signs or components forming words or sentences without clear manual segmentation.

The term “word units” refers to segments of text corresponding to individual words or lexical items in a natural language, obtained by processing recognized gesture expressions.

The term “sentence units” refers to text segments that form complete sentences according to the grammatical rules of a natural language, derived from the recognized continuous gesture expressions.

The term “high accuracy” refers to a level of recognition or conversion performance in which an output, such as a character string, corresponds to an intended gesture expression with a reduced error rate compared to conventional systems, under comparable conditions.

In one embodiment, a server cooperates with a terminal and a user to implement the claimed system. The server includes at least one processor, a main memory, a non-volatile storage device, a network interface, and one or more hardware accelerators such as a graphics processing unit. The terminal includes an imaging device, a display, an acoustic output device, and optionally a microphone and additional sensors. The user performs gesture expressions, including sign language, in front of the imaging device of the terminal.

Server executes software modules stored in the non-volatile storage device and loaded into main memory. The software modules include a video reception module, a preprocessing module, a feature extraction module, a sign-language recognition module, a generative AI interface module, an emotion recognition module, a text-to-speech interface module, and a communication control module. In one example, Server uses a computer-vision library such as OpenCV for image processing, a machine learning framework such as TensorFlow for implementing neural network models, and a text-to-speech service such as a generic cloud-based text-to-speech API. Server can also use a cloud-based generative AI model accessible via an application programming interface, and a generic emotion-recognition application programming interface for estimating emotion from facial images and audio.

Terminal captures visual information by operating the imaging device, for example a digital camera integrated into a smartphone, tablet, or wearable device. Terminal converts light from the environment into digital image data using a solid-state image sensor and an image signal processor. Terminal then encodes the digitized frames using a video codec and transmits the encoded stream to Server through the network interface. Terminal also captures an audio signal from the microphone, converts the signal into digital samples, and can transmit the audio samples to Server in parallel with the video data. Terminal receives audio data and text data from Server, converts the audio data into an analog signal, and reproduces the sound via the acoustic output device while presenting the text data on the display.

User performs gesture expressions, such as sign language phrases and sentences, using hands, arms, and facial expressions, while standing or sitting within the field of view of the imaging device of Terminal. User may also produce vocal sounds that represent prosodic cues or partial speech. User can perform, for example, a sign-language expression corresponding to “I am looking for a product” or “Thank you,” with an associated emotional state such as joy or frustration.

Server receives the encoded video stream and decodes the stream into a sequence of frames. Server uses OpenCV to convert the color format, to normalize the resolution, and to perform pre-processing operations including denoising, contrast adjustment, and histogram equalization. Server applies background removal and region-of-interest detection to isolate the user's body parts, such as hands and face, from the background. Server then constructs data structures representing each frame, such as two-dimensional arrays of pixel values, and stores them in a frame buffer.

Server extracts feature information from the sequence of frames. In one embodiment, Server implements a pose estimation sub-module that detects keypoints of the user's body, including wrist, elbow, shoulder, and finger joints. Server uses a convolutional neural network to process each frame and to output confidence maps for each keypoint. Server applies non-maximum suppression and soft-argmax operations to determine the coordinates of each keypoint. Server organizes the keypoint coordinates across multiple frames into a time-series feature sequence, represented as a tensor with dimensions for time steps, keypoints, and coordinate channels. Server may also compute additional motion features such as inter-frame differences, optical flow, and joint velocities, and appends these features to the time-series feature sequence.

Server executes the sign-language recognition module implemented in TensorFlow. In one embodiment, Server uses a recurrent neural network, such as a bidirectional long short-term memory network, or a Transformer-based sequence model. Server feeds the time-series feature sequence into the input layer of the neural network. The network contains multiple layers of linear transformations, non-linear activation functions, and possibly attention mechanisms. Server uses an output layer configured to produce probability distributions over symbol units, such as word tokens or subword units, at each time step. Server applies a decoding algorithm, for example beam search or a connectionist temporal classification decoding procedure, to convert the probability distributions into a sequence of discrete tokens. Server concatenates the tokens into a base text string that represents the recognized content of the gesture expression. This base text is encoded in a character encoding format and stored in a data structure that includes metadata such as time stamps and recognition confidence values.

Server improves recognition accuracy and robustness through the particular combination of time-series feature extraction and sequence modeling. Because Server analyzes not only static hand shapes but also temporal dynamics and multi-joint motion patterns, the system achieves higher recognition accuracy than conventional frame-by-frame template matching. The neural network can model long-range dependencies in the gesture sequence, which enables recognition of continuous sign-language sentences and reduces segmentation errors. This technical effect arises from the specific design of the feature extraction and neural architecture rather than a mere automation of human interpretation.

Server interfaces with a generative AI model through the generative AI interface module. Server constructs a prompt sentence that includes at least the base text and can also include style instructions or context. For example, Server can form the following prompt sentence:

“Convert the recognized sign language sentence ‘I am looking for a product’ into a polite spoken sentence that a store clerk can easily understand.”

In another example, Server can form:

“Recognized sentence: ‘I am looking for a product.’ Detected emotion: joy. Generate a spoken sentence that conveys both the content and the emotion.”

Server transmits the prompt sentence to the generative AI model through an application programming interface. The generative AI model, implemented as a large-scale neural network such as a Transformer with multiple attention layers, processes the prompt sentence token by token and generates natural language text. Server receives the generated text and stores it as refined text. Because the generative AI model leverages a large parameter space and pretrained linguistic knowledge, it can refine the base text into more natural, context-appropriate speech, for example:

“Excuse me, I am looking for a product. Could you help me find it?”

By controlling the generative AI model through carefully constructed prompt sentences that include recognized gesture content and style constraints, Server applies a non-conventional text generation sequence. The generative refinement step is not a simple template fill-in; it uses the generative model's internal statistical structure to improve fluency, word choice, and politeness level. This leads to a technical improvement in the quality and usability of the text provided to the speech synthesis engine.

Server implements an emotion recognition module to generate emotion information from multimodal input. Server receives face images and audio samples from Terminal and applies computer vision algorithms and audio analysis algorithms. For facial emotion recognition, Server uses a convolutional neural network that takes as input cropped face images and outputs emotion class probabilities for categories such as happiness, sadness, anger, and neutrality. Server computes feature maps, applies pooling operations, and feeds the results through fully connected layers to obtain an emotion vector. For voice-based emotion estimation, Server extracts spectral features such as mel-frequency cepstral coefficients, pitch contours, and energy contours. Server feeds these features into a neural classifier or another machine learning model to obtain an emotion prediction. Server then fuses the outputs from the facial and voice analyses, for example by weighted averaging or another fusion rule, to generate emotion information including an emotion type and an emotion intensity measure.

Server adds the emotion information to the prompt sentence for the generative AI model or uses the emotion information to select or modify templates in a rule-based text augmentation mechanism. For example, Server can generate a text such as “He is happy” or can request the generative AI model to embed the emotional nuance into the refined text. This integration of emotion information into text generation distinguishes the system from conventional architectures where emotion is only used at the prosody control stage. By propagating emotion information into both lexical choice and speech parameters, the system yields output that better matches the user's intended communicative state, and this coordinated handling improves the effectiveness of the overall communication pipeline.

Server converts the natural language text into audio data using a text-to-speech interface module. Server structures a request containing the text, language settings, and prosodic parameters. The prosodic parameters include fundamental frequency, speaking rate, and volume, which Server determines in part from the emotion information. For example, when the emotion type is joy with high intensity, Server increases the fundamental frequency and speaking rate slightly, and when the emotion type is sadness with high intensity, Server reduces the speaking rate and slightly lowers the fundamental frequency. Server submits the request to a text-to-speech service and receives encoded audio data. Server can perform additional processing such as resampling, normalization, or trimming. Server then transmits the processed audio data to Terminal for playback.

Terminal receives the text and audio from Server. Terminal displays the text on the display, for example showing “I am looking for a product. (happy)” while playing the corresponding audio. Terminal's audio subsystem decodes the received audio stream, fills an audio buffer, and drives the digital-to-analog converter and amplifier connected to the acoustic output device. This hardware-level signal chain transforms the computed digital representation into an audible, emotion-infused spoken message that a hearing person can perceive and respond to in real time.

This architecture provides specific technical effects beyond mere automation of human activities. The use of time-series feature sequences and deep sequence models increases recognition accuracy and robustness for continuous gesture expressions in noisy environments, which directly improves performance metrics such as word error rate and latency. The use of generative AI controlled by structured prompt sentences enables the processor to produce contextually appropriate and natural phrasing without relying on hand-crafted templates, thereby reducing rule complexity and storage requirements for templates. The coordinated use of emotion information for both lexical generation and prosodic control yields more consistent and interpretable audio output, which reduces misunderstanding and error in downstream human-computer interactions. Furthermore, the server-side processing pipeline is designed to minimize communication load: by transmitting compressed video and audio to Server for high-level recognition and then returning compact text and encoded audio segments, the system reduces the need for constant high-bandwidth bidirectional streaming of raw data.

Server trains the machine learning models offline before deployment. For the sign-language recognition model, Server constructs a training dataset containing sequences of keypoint features and corresponding text labels. Server initializes the network weights and applies a supervised learning procedure using a loss function such as cross-entropy or a connectionist temporal classification loss, depending on the output structure. Server updates weights using a gradient-based optimization algorithm such as stochastic gradient descent or adaptive gradient methods. Server may employ data augmentation techniques such as temporal scaling, spatial perturbations of keypoint positions, and random noise addition to improve generalization to different users and environments. For the emotion recognition model, Server collects face images and audio samples labeled with emotion categories and trains separate or joint models using similar supervised learning methods.

Server implements specific data structures and module interfaces to support efficient operation. For example, Server uses a unified feature tensor format for time-series gesture features, where each tensor includes a header specifying frame rate, number of keypoints, and feature dimensions. Server also defines a prompt object that contains fields for base text, context tags, emotion information, and style parameters. The generative AI interface module serializes this object into a prompt sentence that follows a predefined template, ensuring deterministic behavior in how the generative model is guided. By using structured internal representations and deterministic prompt construction, Server improves reproducibility and debuggability of text generation behavior, which is not achievable by simply asking a model to “interpret” input in an unrestricted manner.

Alternative embodiments can modify specific components while maintaining the overall architecture. Server can replace the recurrent network with a Transformer encoder-decoder to model long-range dependencies more effectively. Server can implement an on-premises neural text-to-speech engine instead of a remote service, enabling lower latency and more fine-grained control. Server can distribute some preprocess steps to Terminal, such as local face detection or downsampling of frames, to reduce network traffic and to offload some computational burden from Server. Server can also adapt the model architectures and parameters for different deployment environments, such as embedded processors in wearable devices or large-scale cloud servers for high-volume processing.

User can employ the system in various contexts such as retail stores, public service counters, hospitals, or educational settings. When User signs “Where is this product?” with a joyful expression, Terminal captures the multimodal signals and Server processes them according to the described architecture. The system outputs not only an accurate spoken question but also a voice that reflects the joyful emotion, allowing the hearing person to respond appropriately. When User signs “Thank you” with a smile, Server recognizes the gesture, refines the text using a generative AI model by applying a prompt sentence such as:

“When sign language for ‘Thank you’ is performed with joy, generate the expected spoken output text and describe the tone of voice.”

Server then generates and synthesizes a spoken message such as “Thank you so much!” in a bright tone, which is played through Terminal. This interaction illustrates how the described combination of feature extraction, neural recognition, generative text refinement, and emotion-based prosody control yields an integrated, technically improved multimodal communication system that operates on real-world sensor data and controls concrete hardware elements such as cameras, processors, displays, and speakers.

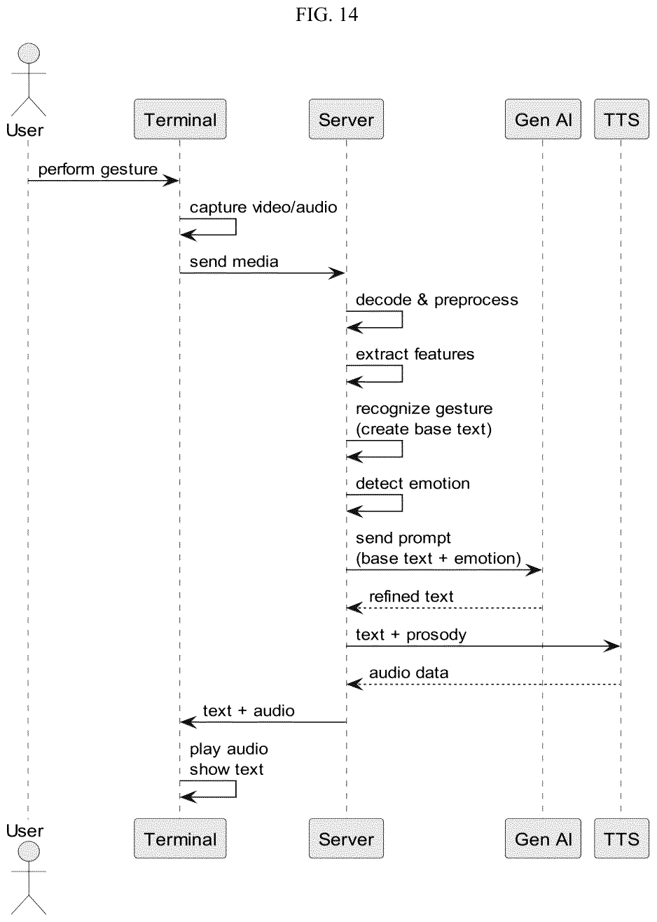

The following describes the processing flow using FIG. 14.

Step 1:

User performs a gesture expression, such as a sign-language sentence, in front of the imaging device of Terminal while optionally producing corresponding facial expressions and voice.

User provides, as an input, physical body motions (hand, arm, body posture), facial movements, and acoustic vibrations (voice), which are not yet digitized data.

User continuously moves hands and arms in specific shapes and trajectories that encode linguistic content, for example forming the sign sequence for “I am looking for a product.” User also adjusts facial expression, such as smiling to indicate joy, and may utter non-verbal sounds that carry prosodic cues.

Step 2:

Terminal captures visual and audio information from User and converts the information into digital sensor data.

Terminal receives, as an input, optical signals arriving at the camera sensor and acoustic waves arriving at the microphone.

Terminal operates a camera module to expose an image sensor at a fixed frame rate (e.g., 30 frames per second), converts analog photocharge into digital pixel values via an analog-digital converter, and arranges the pixel values into image frames encoded in a format such as YUV or RGB. Terminal simultaneously samples the microphone signal at a fixed sampling rate (e.g., 16 kHz), converts analog voltages into 16-bit PCM samples, and buffers the samples. Terminal then performs data processing that includes color space conversion, compression by a video codec (e.g., H.264), and packaging of audio samples into an audio stream, and outputs compressed video and audio streams as digital data ready for transmission.

Step 3:

Terminal transmits the captured video and audio data to Server over a communication network.

Terminal takes, as an input, the compressed video and audio streams generated in Step 2.

Terminal divides the streams into network packets, adds protocol headers (e.g., IP, TCP/UDP, application-level headers), and sends the packets via a network interface such as Wi-Fi or cellular communication. Terminal may use secure transport protocols to ensure integrity. The main data processing includes packetization, buffering, and scheduling based on network bandwidth. Terminal outputs a continuous sequence of network packets that represent the time-series visual and audio data, and Server receives these packets.

Step 4:

Server receives, decodes, and pre-processes the video and audio streams to produce normalized frame and audio data.

Server accepts, as an input, the network packets created by Terminal that carry compressed video and audio streams.

Server reassembles packets in order, detects and corrects any transmission errors where possible, and forwards the payload to a media decoding module. Server uses a software library to decode the video codec into raw frames (arrays of pixel values) and to decode the audio codec into PCM samples. Server then applies image pre-processing operations using a computer-vision library: converting color space from YUV to RGB, resizing frames to a fixed resolution (e.g., 256×256 pixels), and normalizing pixel intensities (e.g., scaling to [0,1]). For the audio, Server normalizes volume and may perform noise reduction. Server outputs a sequence of normalized image frames and corresponding audio sample sequences.

Step 5:

Server extracts body and hand features from the pre-processed image frames to form a time-series feature sequence.

Server takes, as an input, the normalized sequence of image frames from Step 4.

Server executes a pose estimation module implemented with a convolutional neural network or other machine learning model. For each frame, Server runs the network to compute heatmaps for body and hand keypoints, applies non-maximum suppression to find peak responses, and calculates two-dimensional coordinates for each keypoint (e.g., wrist, knuckle, fingertip, elbow). Server then links keypoints across frames by time index and stores them in a tensor with shape [T, J, C], where T is the number of frames, J is the number of joints, and C is the coordinate channels. Server may compute additional features such as joint velocity (difference of coordinates between frames) and joint acceleration, and concatenates these metrics to each time step's feature vector. Server outputs a structured time-series feature sequence representing User's gesture motion.

Step 6:

Server recognizes the gesture content by applying a sign-language recognition model to the time-series feature sequence and generating base text.

Server receives, as an input, the time-series feature sequence constructed in Step 5.

Server feeds this tensor into a machine learning model such as a recurrent neural network, a Transformer, or another sequence model implemented with a machine learning framework. The model performs matrix multiplications, non-linear activations, and attention computations across the time dimension to map sequences of feature vectors to sequences of linguistic tokens (e.g., word indices). Server applies a decoding algorithm such as beam search or a temporal classification decoding to select the most probable token sequence given the model's output distributions. Server then converts the token sequence into a human-readable character string, encodes it in a standard text format, and stores it as base text. For example, Server outputs base text “I am looking for a product.” along with associated confidence scores.

Step 7:

Server analyzes facial and voice data to estimate User's emotional state and produces emotion information.

Server takes, as an input, cropped face images derived from the frames in Step 4 and synchronized audio samples, if available.

Server applies a facial emotion recognition model to each face image. The model, implemented as a convolutional neural network, outputs probabilities for emotion categories (such as joy, sadness, anger, and neutral). Server aggregates probabilities across frames, for example by averaging or time-weighted averaging. For voice-based emotion, Server extracts spectral features such as mel-frequency cepstral coefficients, pitch contours, and energy envelopes from the audio samples, then applies a classifier model to estimate emotional state. Server fuses the facial and voice estimates using a rule such as weighted averaging or maximum-probability selection to create a unified emotion vector. Server then converts this vector into emotion information that includes an emotion type (e.g., joy) and an emotion intensity value (e.g., 0.8). Server outputs a structured emotion object that can be referenced in later processing.

Step 8:

Server constructs a prompt sentence that conveys the recognized base text and, optionally, the emotion information, for submission to the generative AI model.

Server receives, as an input, the base text from Step 6 and the emotion information from Step 7.

Server creates a data structure that contains fields for recognized sentence, emotion type, emotion intensity, and desired style of speech (such as polite, casual, or explanatory). Server formats this structure into a natural-language prompt sentence according to a predetermined template. For example, Server constructs a prompt sentence such as: “Convert the recognized sign language sentence ‘I am looking for a product’ into a polite spoken sentence that a store clerk can easily understand.” When emotion information is included, Server may create:

“Recognized sentence: ‘I am looking for a product.’ Detected emotion: joy. Generate a spoken sentence that conveys both the content and the emotion.” Server outputs this prompt sentence as plain text ready to be sent to a generative AI model.

Step 9:

Server calls a generative AI model with the prompt sentence and obtains refined natural language text.

Server uses, as an input, the prompt sentence generated in Step 8.

Server transmits the prompt sentence to an external generative AI service or to a locally hosted generative model via an application programming interface. The service internally encodes the input text into token IDs and processes them through a multi-layer sequence model, such as a Transformer network with attention heads and feedforward sub-layers. The model computes probability distributions over tokens for each generation step and samples or selects tokens to form an output sequence. Server receives the output token sequence, converts it back into text, and may perform post-processing such as trimming, punctuation cleanup, and length control. Server outputs a refined text string that better matches natural spoken usage, for example “Excuse me, I am looking for a product. Could you help me find it?”

Step 10:

Server composes final text by combining refined text and emotion-related phrases, if necessary.

Server takes, as an input, the refined text from Step 9 and the emotion information from Step 7.

Server may decide, based on configuration, whether to insert explicit emotion description or to leave emotion only for prosodic control. If explicit description is needed, Server may apply template-based rules or send an additional prompt to the generative AI model. For example, Server can append an additional phrase “He is happy” or ask the model via a second prompt to create a single sentence that integrates emotion, such as “I'm happily looking for a product; could you help me find it?” Server merges the results and outputs final text which includes both the semantic content and any emotion-related language, stored as a character string for subsequent speech synthesis.

Step 11:

Server prepares a text-to-speech request and converts the final text into audio data with emotion-based prosody.

Server receives, as an input, the final text from Step 10 and the emotion information from Step 7.

Server sets parameters for synthetic speech, including language code, voice type, fundamental frequency, speaking rate, and volume. Server adjusts these parameters according to emotion: for joyful emotion, Server increases pitch and speaking rate slightly; for sad emotion, Server decreases speaking rate and slightly lowers pitch. Server composes a request message containing the final text and prosody parameters, and sends this request to a text-to-speech engine via an application programming interface. The engine internally performs linguistic analysis, prosody generation, and waveform synthesis via digital signal processing or neural vocoding. Server receives the resulting audio data, typically as a compressed audio stream or linear PCM samples. Server may perform additional processing such as normalization and trimming of silence. Server outputs ready-to-play audio data associated with the final text.

Step 12:

Server sends the synthesized audio data and the final text to Terminal for presentation.

Server takes, as an input, the processed audio data from Step 11 and the final text from Step 10.

Server encapsulates the audio data into network packets, along with metadata such as sample rate, bit depth, and language. Server includes the final text as a separate payload or metadata field. Server then transmits these packets to Terminal over the network, using a reliable transport protocol. Server may segment longer audio into chunks and include sequence numbers to ensure correct ordering. Server outputs a network stream that delivers both audio content and corresponding text to Terminal.

Step 13:

Terminal receives the audio and text, plays the audio through the acoustic output device, and displays the text on the display.

Terminal uses, as an input, the network packets from Step 12 containing audio data and text data.

Terminal reassembles the packets, extracts the audio buffer and the text string, and routes them to appropriate subsystems. Terminal configures an audio playback pipeline (e.g., sets sample rate to match the audio format), fills an internal audio buffer with the received samples, and starts playback through a digital-to-analog converter, amplifier, and loudspeaker. In parallel, Terminal updates the display content to show the text, for example “Excuse me, I am looking for a product. Could you help me find it? (happy)”. This data processing converts digital audio stream into physical sound waves and digital text into visible characters on the screen. Terminal outputs audible speech that a hearing person can understand and a visual representation that both User and the hearing person can reference.

Step 14:

User and a hearing person interact based on the output, and User may generate follow-up gesture expressions for continued communication.

User takes, as an input, the audio and text output from Terminal in Step 13.

User observes the reaction of the hearing person and, if further clarification or requests are needed, performs additional gesture expressions and facial cues, starting a new cycle of processing from Step 1. User may, for instance, sign “Where is this product?” or “Thank you,” again with emotion, thereby providing new physical input signals for Terminal and Server to process.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

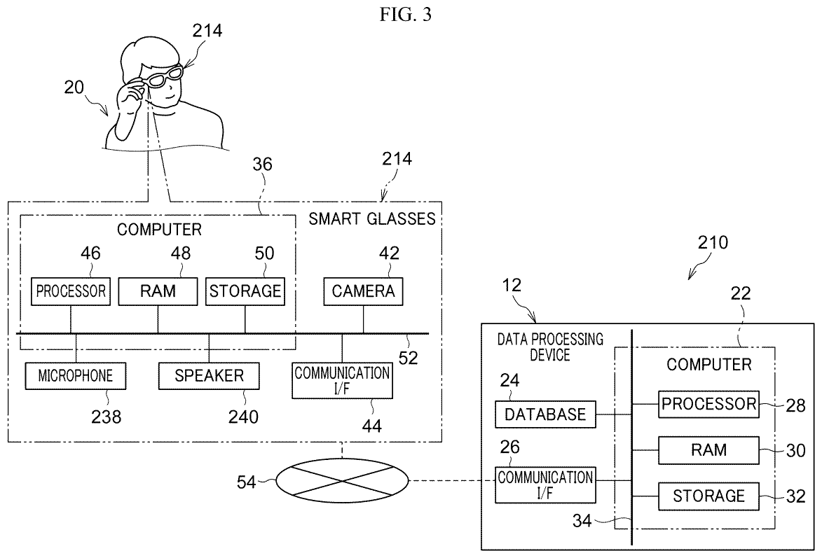

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

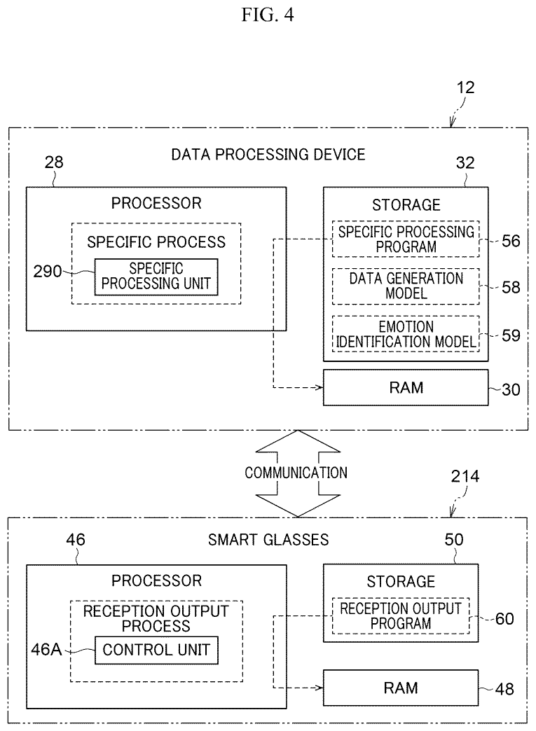

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

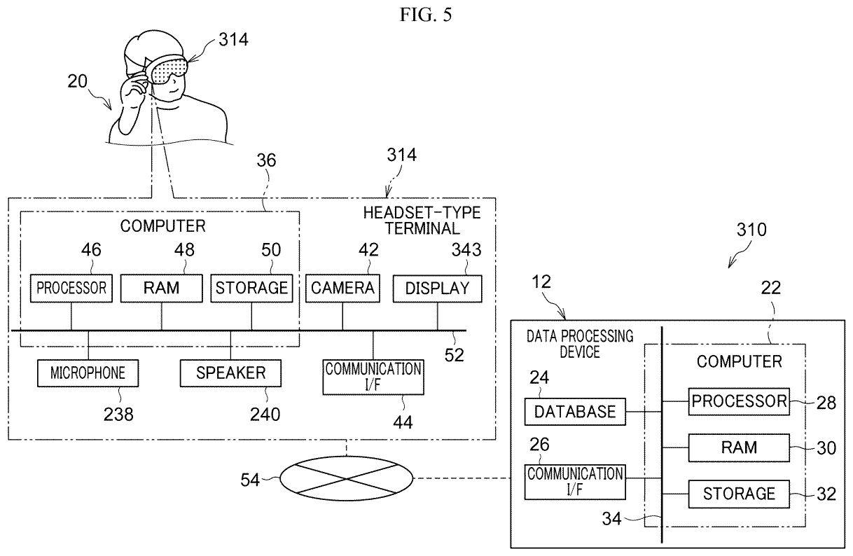

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

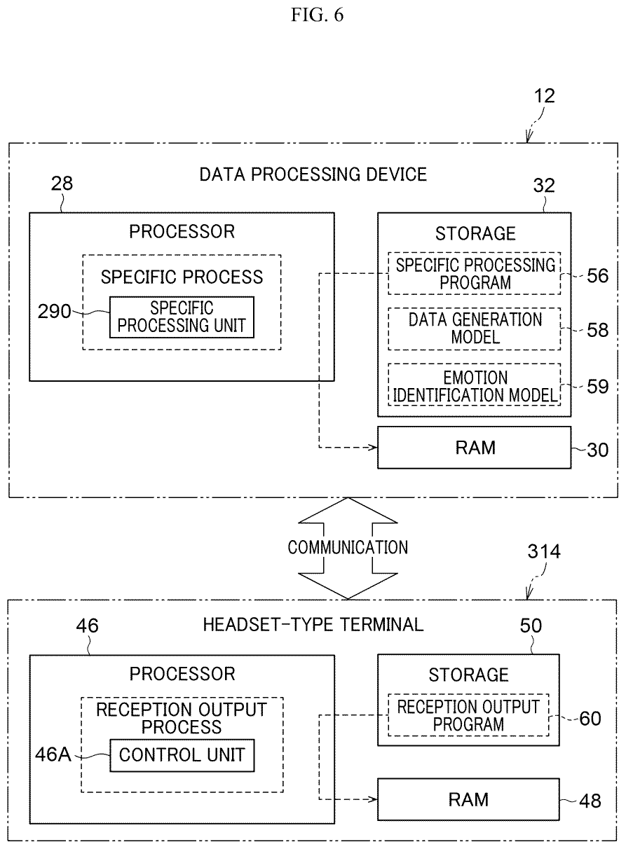

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

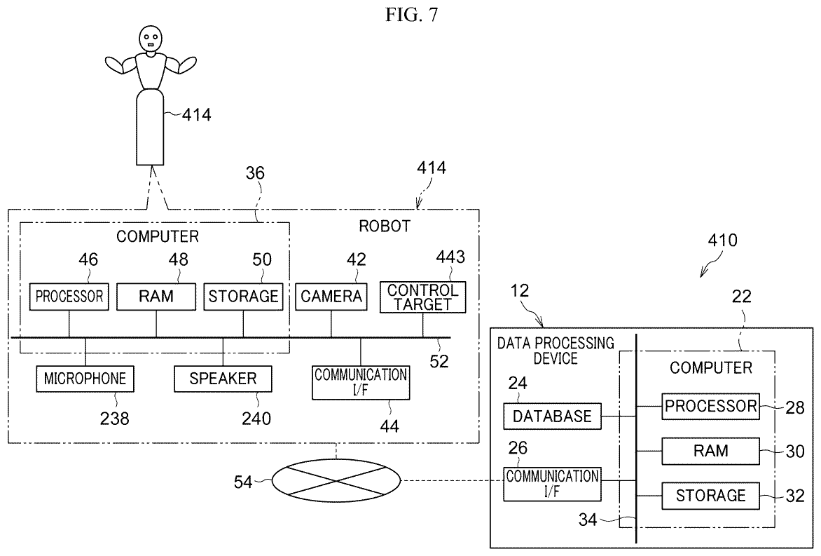

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

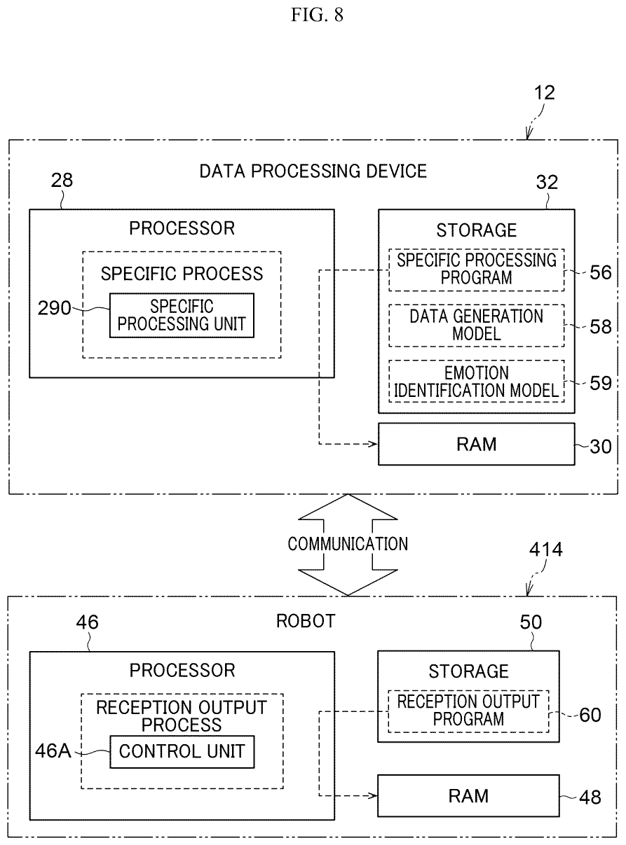

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

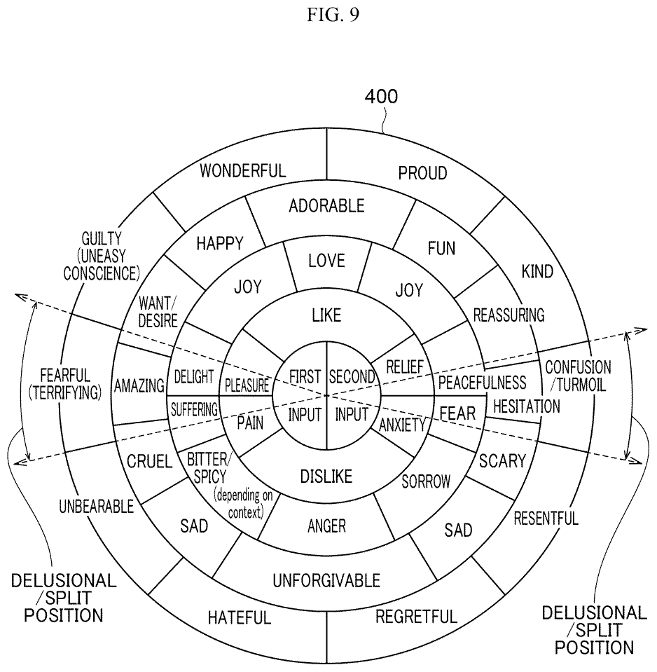

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

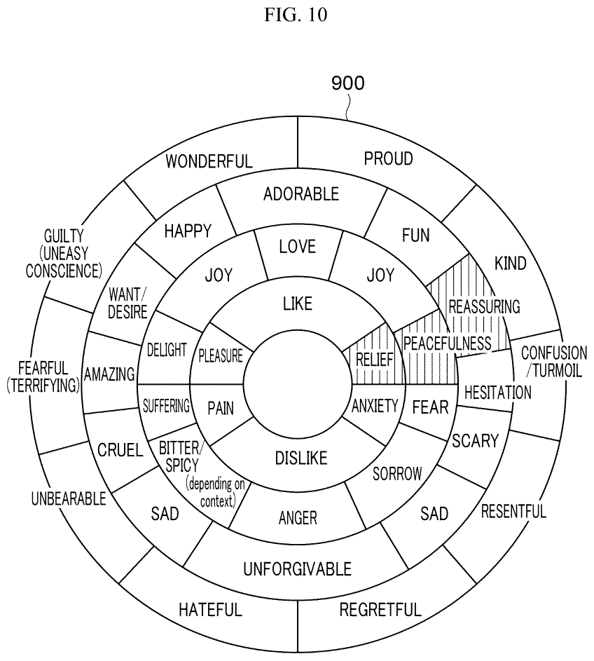

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to

acquire motion image information including gestural movement by using an image acquisition device, and perform preprocessing by dividing the motion image information into time-series image units, the preprocessing including at least resizing an image, normalizing pixel values, extracting a body-part region, cutting out a motion region, and segmenting a motion interval,

input the preprocessed time-series image information or body joint position information extracted from the image information into a machine learning model, recognize character-string information representing semantic content of the gestural movement based on an output of the machine learning model, generate a prompt sentence for instructing a generative AI model to generate character-string information in a natural-language sentence form based on a recognition result, and obtain the character-string information in the natural-language sentence form from the generative AI model in response to the prompt sentence, and

input the character-string information in the natural-language sentence form into a speech synthesis processing unit, generate audio parameters and speech feature values to thereby generate audio data, transmit the audio data to a terminal device via a communication path, and cause the audio data to be output as physical sound through an acoustic output device connected to the terminal device.

### (Supplementary 2)

The system according to supplementary 1,

wherein the processor is configured to

acquire expression information or voice information of a user, estimate an emotional state by analyzing the expression information or the voice information, and apply an intonation parameter or a voice-quality parameter corresponding to the emotional state to the speech synthesis processing unit so that the audio data for the character-string information in the natural-language sentence form is generated with a voice tone corresponding to the emotional state.

### (Supplementary 3)

The system according to supplementary 1,

wherein the processor is configured to

continuously acquire the motion image information by the image acquisition device as the time-series image units, execute body-part position estimation processing and motion-feature extraction processing for each of the time-series image units, and automatically determine a start and an end of the motion interval based on a motion feature and perform recognition of the semantic content of the gestural movement by the machine learning model for each time-series interval.

### Application Example 1

### (Supplementary 1)

A system comprising a processor,

wherein the processor is configured to

acquire image information including sign language motion by using an imaging apparatus, perform preprocessing on the image information to extract a region including the sign language motion, and segment the image information into temporal sections based on a start and an end of the sign language motion,

extract body-part feature information from the image information for each of the temporal sections, generate a symbol sequence corresponding to a sign-language expression based on the feature information, generate a prompt sentence including the symbol sequence and associated auxiliary information, and input the prompt sentence to a generative AI model so as to cause the generative AI model to generate text information in a natural language,

generate a prompt sentence for performing notation-unification processing and style-conversion processing on the generated text information, input the prompt sentence to the generative AI model so as to generate formatted text information for speech, input the formatted text information to a speech-generation processing unit to convert the formatted text information into acoustic information, and output the acoustic information in real time via an output device,

display the formatted text information on a display device, and control execution of conversion processing into the acoustic information or execution of re-input processing based on a confirmation operation from a user, and

store the generated text information and the formatted text information in association with the image information and the acoustic information, and generate learning data for improving sign-language motion recognition processing and text-information generation processing based on stored contents.

### (Supplementary 2)

The system according to supplementary 1,

wherein the processor is configured to

include, as prompt sentences input to the generative AI model, at least a first prompt sentence prompting generation of natural-language text information from the symbol sequence corresponding to the sign-language expression, and a second prompt sentence prompting conversion of the natural-language text information into a speech-oriented expression including a politeness expression, and to perform, in stages, generation and formatting of the text information by using the plurality of prompt sentences.

### (Supplementary 3)

The system according to supplementary 1,

wherein the processor is configured to

accumulate, as log information, the image information, the generated text information, the formatted text information, the acoustic information, and evaluation information from the user, and improve both recognition processing based on the feature information and contents of the prompt sentences input to the generative AI model, by updating the recognition processing and the contents of the prompt sentences using the log information so as to enhance recognition accuracy of the sign-language motion and expression quality of the natural-language text information.

### Example 2

### (Supplementary 1)

A system comprising a processor,

wherein the processor is configured to

acquire motion information including movements of fingers and a body by using an imaging device and generate time-series image data based on the acquired motion information, extract sequences of feature points of body parts from the image data, recognize, based on the sequences of feature points, an intermediate representation sequence indicating predetermined motion expressions, generate a prompt sentence that instructs a generative AI model to generate natural-language character information using the intermediate representation sequence as input information, and obtain the character information from the generative AI model based on the prompt sentence,

execute speech synthesis processing to convert the obtained character information into an acoustic signal and output the acoustic signal via an acoustic output device, and

transmit and receive at least one of the image data and the character information through a communication path to and from an external device, and distribute and execute at least one of acoustic-signal generation processing and image-data analysis processing to the external device.

### (Supplementary 2)

The system according to supplementary 1,

wherein the processor is configured to

generate context information of a dialogue based on the intermediate representation sequence and the character information, and include the context information in the prompt sentence so as to control generation content of the character information by the generative AI model.

### (Supplementary 3)

The system according to supplementary 1,

wherein the processor is configured to

analyze at least one of expression information and voice information from the image data to estimate an emotional state, and change a speaker characteristic parameter in the speech synthesis processing according to the estimated emotional state.

### Application Example 2

### (Supplementary 1)

A system comprising a processor,

wherein the processor is configured to

acquire visual information including a gesture expression by using an imaging device, and analyze the acquired visual information to recognize content of the gesture expression, and use feature information extracted from the visual information to input a time-series body motion into a machine learning model, and generate base text including a character string corresponding to the gesture expression, and

generate a prompt sentence including the base text and a desired style of spoken language, and input the prompt sentence into a generative information processing model to cause the generative information processing model to generate natural language text, and

input the natural language text output from the generative information processing model into a speech synthesis technique that performs acoustic signal generation processing to convert the natural language text into audio data, and output the audio data through an acoustic output device, and

transmit the natural language text and the audio data to a terminal device, and cause the terminal device to display the natural language text and to reproduce the audio data.

### (Supplementary 2)

The system according to supplementary 1,

wherein the processor is configured to

acquire a face image of a user and an audio signal of the user, extract feature information indicating an emotional state from the face image and the audio signal to generate emotion information including an emotion type and an emotion intensity, add the emotion information to the prompt sentence and input the prompt sentence into the generative information processing model to cause the generative information processing model to generate natural language text reflecting both the content of the gesture expression and a nuance of the emotion, and control a fundamental frequency, a speaking rate, and a volume of the speech synthesis technique in accordance with the emotion information to generate audio data having an emotion tone.

### (Supplementary 3)

The system according to supplementary 1,

wherein the processor is configured to

divide the visual information into a plurality of frames at predetermined time intervals, extract position information and motion information of body parts from each frame to generate a time-series feature sequence, and operate the machine learning model by using the time-series feature sequence so as to convert a continuous gesture expression into a character string of word units or sentence units with high accuracy.

What is claimed is:

1. A system comprising:
circuitry configured to:
receive, via a communication interface coupled to a packet-switched network, video data captured by a camera of a terminal device, the video data comprising a sequence of image frames representing sign language gestures of a user;
analyze the video data on a frame-by-frame basis using a gesture recognition model to extract hand shape features, hand position coordinates, and motion vectors from successive image frames, and recognize content of the sign language based on the extracted features;
generate a prompt sentence for a generative neural network model based on the recognized sign language content, and transmit the prompt sentence to the generative neural network model to acquire text data representing the recognized content;
obtain emotion-state information of the user by analyzing at least one of facial expression data and voice signal data received from the terminal device using an emotion recognition model; and
apply speech synthesis processing to the text data to generate audio data, wherein a voice tone parameter of the speech synthesis processing is adjusted based on the emotion-state information, and transmit the audio data via the communication interface to the terminal device for output through an audio output device.

2. The system according to claim 1, wherein the circuitry is configured to extract, from each image frame, a set of hand keypoint coordinates using a convolutional neural network, and to compute temporal motion vectors between successive frames based on the keypoint coordinates.

3. The system according to claim 2, wherein the circuitry is configured to apply a sequence model to the temporal motion vectors across a plurality of successive image frames to recognize continuous sign language phrases from the motion sequence.

4. The system according to claim 3, wherein the circuitry is configured to segment the video data into sign unit intervals based on transitions detected in the motion vectors, and to independently recognize sign language content for each sign unit interval.

5. The system according to claim 4, wherein the circuitry is configured to compute a confidence score for each recognized sign unit interval and to re-query the generative neural network model with a modified prompt sentence when a confidence score falls below a predetermined threshold.

6. The system according to claim 1, wherein the circuitry is configured to obtain the emotion-state information by applying an emotion recognition model to facial landmark coordinates extracted from the video data, the facial landmark coordinates representing facial muscle configurations associated with emotional expressions.

7. The system according to claim 6, wherein the circuitry is configured to determine an emotion label and an emotion intensity value from the facial landmark coordinates, and to map the emotion label and the emotion intensity value to a corresponding voice tone parameter comprising at least one of pitch, speaking rate, and energy level for the speech synthesis processing.

8. The system according to claim 7, wherein the circuitry is configured to process voice signal data received from the terminal device to extract prosodic features, combine the prosodic features with the emotion label derived from the facial landmark coordinates, and compute a combined emotion-state score for adjusting the voice tone parameter.

9. The system according to claim 8, wherein the circuitry is configured to monitor changes in the combined emotion-state score over successive interaction turns and dynamically update the voice tone parameter for each subsequent audio output to maintain emotional continuity.

10. The system according to claim 1, wherein the circuitry is configured to construct the prompt sentence to include the recognized sign language content, a contextual description of the sign language type, and a style instruction specifying a target naturalness level for the text data generated by the generative neural network model.

11. The system according to claim 10, wherein the circuitry is configured to transmit the prompt sentence to the generative neural network model via an external API endpoint and receive the text data comprising one or more natural language sentences representing the sign language content.

12. The system according to claim 11, wherein the circuitry is configured to evaluate the text data for semantic consistency with the recognized sign language content using a similarity scoring function, and to regenerate the text data when a similarity score falls below a predetermined consistency threshold.

13. The system according to claim 12, wherein the circuitry is configured to apply a post-processing function to the text data to correct grammatical errors and normalize sentence structure prior to speech synthesis processing.

14. The system according to claim 1, wherein the circuitry is configured to store interaction history comprising prior recognized sign language content, generated text data, and corresponding audio data, and to incorporate the interaction history into subsequently generated prompt sentences to maintain conversational context.

15. The system according to claim 14, wherein the circuitry is configured to retrieve, from the interaction history, a prior conversational segment and to include the prior conversational segment as context in a subsequent prompt sentence to improve coherence of the generated text data.

16. The system according to claim 1, wherein the circuitry is configured to receive a second video data stream from a hearing user terminal device, apply speech recognition processing to audio data associated with the second video data stream to generate response text data, and transmit the response text data to the terminal device of the sign language user for display.

17. The system according to claim 1, wherein the circuitry is configured to switch between a high-parameter gesture recognition model and a distilled gesture recognition model based on a measured inference latency, wherein the circuitry switches to the distilled gesture recognition model when the measured inference latency exceeds a predetermined latency threshold.

18. A system comprising:
circuitry configured to:
receive, via a communication interface coupled to a packet-switched network, video data captured by a camera of a terminal device, the video data comprising image frames representing sign language gestures of a user;
apply a convolutional neural network to each image frame to extract hand keypoint coordinates, compute temporal motion vectors between successive frames, and apply a sequence model to the motion vectors to recognize content of the sign language;
generate a prompt sentence for a generative neural network model based on the recognized sign language content, transmit the prompt sentence to the generative neural network model, and receive text data representing the recognized content;
apply an emotion recognition model to at least one of facial landmark coordinates extracted from the video data and prosodic features extracted from voice signal data to determine an emotion label and an emotion intensity value; and
apply speech synthesis processing to the text data with a voice tone parameter adjusted based on the emotion label and the emotion intensity value, and transmit resulting audio data to the terminal device for output.

19. The system according to claim 18, wherein the circuitry is configured to map the emotion label and the emotion intensity value to a voice tone parameter comprising at least one of pitch, speaking rate, and energy level, and to apply the voice tone parameter during speech synthesis processing to generate emotionally expressive audio data.

20. A method comprising:
receiving, via a communication interface coupled to a packet-switched network, video data captured by a camera of a terminal device, the video data comprising a sequence of image frames representing sign language gestures of a user;
analyzing the video data on a frame-by-frame basis using a gesture recognition model to extract hand shape features, hand position coordinates, and motion vectors from successive image frames, and recognizing content of the sign language based on the extracted features;
generating a prompt sentence for a generative neural network model based on the recognized sign language content, and transmitting the prompt sentence to the generative neural network model to acquire text data representing the recognized content;
obtaining emotion-state information of the user by analyzing at least one of facial expression data and voice signal data received from the terminal device using an emotion recognition model; and
applying speech synthesis processing to the text data to generate audio data, wherein a voice tone parameter of the speech synthesis processing is adjusted based on the emotion-state information, and transmitting the audio data via the communication interface to the terminal device for output through an audio output device.
